(19) United States
(12) Patent Application Publication
(10) Pub. No.: US 2025/0234079 A1
(43) Pub. Date: Jul. 17, 2025

(54) ZOOM LENS AND IMAGING APPARATUS

(71) Applicant: FUJIFILM Corporation, Tokyo (JP)

(72) Inventors: Yuya HIRAKAWA, Saitama (JP); Taiga NODA, Saitama (JP)

(73) Assignee: FUJIFILM Corporation, Tokyo (JP)

(21) Appl. No.: 19/008,166

(22) Filed: Jan. 2, 2025

(30) Foreign Application Priority Data
Jan. 16, 2024 (JP) 2024-004792

(51) Int. Cl. H04N 23/55; H04N 23/67; H04N 23/69

(52) U.S. Cl. CPC H04N 23/55; H04N 23/67; H04N 23/69

(57) ABSTRACT

A zoom lens consists of, in order from an object side to an image side, a first lens group having a positive refractive power, a second lens group having a negative refractive power, an intermediate group, and a final lens group having a positive refractive power. The intermediate group consists of two or three lens groups. During zooming, all spacings between adjacent lens groups change. An aperture stop is disposed between a lens surface of the second lens group closest to the image side and a lens surface of the final lens group closest to the object side. The zoom lens satisfies a predetermined conditional expression.

### CROSS-REFERENCE TO RELATED APPLICATIONS

This application claims priority from Japanese Patent Application No. 2024-004792, filed on Jan. 16, 2024, the entire disclosure of which is incorporated herein by reference.

### BACKGROUND

### Technical Field

The disclosed technology relates to a zoom lens and an imaging apparatus.

### Related Art

In the related art, zoom lenses according to JP2022-051875A, JP2021-192088A, and JP2020-154286A have been known as a zoom lens usable in an imaging apparatus such as a digital camera.

### SUMMARY

There has been a demand for a zoom lens that is configured to be reduced in size and that has a small F-number in an entire magnification range and high optical performance in the entire magnification range. A level of such a demand is increasing every year.

The present disclosure provides a zoom lens that is configured to be reduced in size and that has a small F number in an entire magnification range and has high optical performance in the entire magnification range, and an imaging apparatus comprising the zoom lens.

According to an aspect of the present disclosure, there is provided a zoom lens consisting of, in order from an object side to an image side, a first lens group having a positive refractive power, a second lens group having a negative refractive power, an intermediate group, and a final lens group having a positive refractive power, in which the intermediate group consists of two or three lens groups, during zooming, a spacing between the first lens group and the second lens group changes, a spacing between the second lens group and the intermediate group changes, a spacing between the intermediate group and the final lens group changes, and all spacings between adjacent lens groups in the intermediate group change, an aperture stop is disposed between a lens surface of the second lens group closest to the image side and a lens surface of the final lens group closest to the object side, the first lens group includes, in consecutive order from a position closest to the object side to the image side, a first lens that is a negative lens having a convex surface on the object side, and a second lens that is a positive lens, and Conditional Expressions (1), (2), (3), and (4) are satisfied, which are represented by

$$0 < fw / f 1 < 0.3 \qquad ( 1 )$$

$$0.5 < Fnot / ( ft / fw ) < 1.3 \qquad ( 2 )$$

$$0.15 < Bfw / ( ft \times tan ω t ) < 2 \qquad ( 3 )$$

$$7 < TLt / ( ft \times tan ω t ) < 11. \qquad ( 4 )$$

Symbols are defined as follows. A focal length of an entire system in a state where an infinite distance object is in focus at a wide angle end is denoted by fw. A focal length of the first lens group is denoted by f1. An open F-Number in a state where the infinite distance object is in focus at a telephoto end is denoted by Fnot. A focal length of the entire system in the state where the infinite distance object is in focus at the telephoto end is denoted by ft. A back focus of the entire system as an air conversion distance at the wide angle end is denoted by Bfw. A maximum half angle of view in the state where the infinite distance object is in focus at the telephoto end is denoted by ωt. A sum of the back focus of the entire system as the air conversion distance and a distance on an optical axis from a surface of the first lens on the object side to a lens surface of the final lens group closest to the image side in the state where the infinite distance object is in focus at the telephoto end is denoted by TLt.

In a case where a spacing on the optical axis between the intermediate group and the final lens group in the state where the infinite distance object is in focus at the telephoto end is denoted by dMEt, and a spacing on the optical axis between the intermediate group and the final lens group in the state where the infinite distance object is in focus at the wide angle end is denoted by dMEw, the zoom lens of the aspect preferably satisfies Conditional Expression (5) represented by

$$2 < dMEt / dMEw < 10. \qquad ( 5 )$$

In a case where a paraxial curvature radius of a lens surface of the second lens group closest to the object side is denoted by R2f, and a paraxial curvature radius of the lens surface of the second lens group closest to the image side is denoted by R2r, the zoom lens of the aspect preferably satisfies Conditional Expression (6) represented by

$$- 0.5 < ( R 2 f + R 2 r ) / ( R 2 f - R 2 r ) < 2. \qquad ( 6 )$$

In a case where a refractive index with respect to a d line for a lens closest to the image side in the first lens group is denoted by Nd1r, an Abbe number based on the d line for the lens closest to the image side in the first lens group is denoted by vd1r, a refractive index with respect to a d line for a lens closest to the image side in the second lens group is denoted by Nd2r, and an Abbe number based on the d line for the lens closest to the image side in the second lens group is denoted by vd2r, the zoom lens of the aspect preferably satisfies Conditional Expressions (7), (8), (9), and (10) represented by

$$1.65 < Nd 1 r < 1.8 \qquad ( 7 )$$

$$45 < vd 1 r < 60 \qquad ( 8 )$$

$$1.4 < Nd 2 r < 1 \text{.65} \qquad ( 9 )$$

$$60 < vd 2 r < 100. \qquad ( 10 )$$

The zoom lens of the aspect preferably satisfies Conditional Expression (11) represented by

$$1 < fw / ( ft \times tan ω t ) < 1.45 . \qquad ( 11 )$$

In a case where a distance on the optical axis from the surface of the first lens on the object side to the aperture stop in the state where the infinite distance object is in focus at the wide angle end is denoted by DDL1STw, and a sum of the back focus of the entire system as the air conversion distance and a distance on the optical axis from the surface of the first lens on the object side to the lens surface of the final lens group closest to the image side in the state where the infinite distance object is in focus at the wide angle end is denoted by TLw, the zoom lens of the aspect preferably satisfies Conditional Expression (12) represented by

$$0 < DDL 1 STw / TLw < 0 \text{.65} . \qquad ( 12 )$$

In a case where a center thickness of the first lens is denoted by d1, and an outer diameter of the first lens is denoted by DA1, the zoom lens of the aspect preferably satisfies Conditional Expression (13) represented by

$$0.01 < d1 / DA 1 < 0 \text{.035} . \qquad ( 13 )$$

In a case where a center thickness of a negative lens closest to the image side among negative lenses included in the second lens group is denoted by d2r, and an outer diameter of the negative lens closest to the image side among the negative lenses included in the second lens group is denoted by DA2r, the zoom lens of the aspect preferably satisfies Conditional Expression (14) represented by

$$0.01 < d 2 r / DA 2 r < 0 \text{.04} . \qquad ( 14 )$$

In a configuration in which a focus group that moves along the optical axis during focusing is provided, and the focus group includes at least one negative lens, in a case where a center thickness of a negative lens closest to the image side among negative lenses included in the focus group is denoted by dffr, and an outer diameter of the negative lens closest to the image side among the negative lenses included in the focus group is denoted by DAffr, the zoom lens of the aspect preferably satisfies Conditional Expression (15) represented by

$$0.01 < dffr / DAffr < 0.04 . \qquad ( 15 )$$

In a case where a focal length of the final lens group is denoted by fE, the zoom lens of the aspect preferably satisfies Conditional Expression (16) represented by

$$0 < f 1 / fE < 2. \qquad ( 16 )$$

In a case where a focal length of the second lens group is denoted by f2, the zoom lens of the aspect preferably satisfies Conditional Expression (17) represented by

$$- 2 < fw / f 2 < - 0.7 . \qquad ( 17 )$$

In a configuration in which a focus group that moves along the optical axis during focusing is provided, in a case where a focal length of the second lens group is denoted by f2, and a focal length of the focus group is denoted by ff, the zoom lens of the aspect preferably satisfies Conditional Expression (18) represented by

$$0.2 < f2 / ff < 0.8 . \qquad ( 18 )$$

In a case where a focal length of a lens group having a strongest positive refractive power among the lens groups included in the intermediate group is denoted by fMp, the zoom lens of the aspect preferably satisfies Conditional Expression (19) represented by

$$0.4 < fw / fMp < 2. \qquad ( 19 )$$

In a case where a focal length of a lens group having a strongest positive refractive power among the lens groups included in the intermediate group is denoted by fMp, the zoom lens of the aspect preferably satisfies Conditional Expression (20) represented by

$$1.5 < ft / fMp < 5. \qquad ( 20 )$$

The zoom lens of the aspect preferably satisfies Conditional Expression (1-1) represented by

$$0.1 < fw / f 1 < 0.2 . \qquad ( 1 - 1 )$$

The first lens group may be configured to consist of three lenses.

The second lens group may be configured to consist of four lenses.

The first lens group preferably moves during the zooming.

The zoom lens of the aspect preferably includes 14 or more lenses.

According to another aspect of the present disclosure, there is provided an imaging apparatus comprising the zoom lens according to the aspect of the present disclosure.

In the present specification, the expressions “consists of” and “consisting of” indicate that a lens substantially not having a refractive power, an optical element other than a lens, such as a stop, a filter, and a cover glass, a mechanism part such as a lens flange, a lens barrel, an imaging element, and a camera shake correction mechanism may be included in addition to the illustrated constituents.

The term “group having a positive refractive power” in the present specification means that the entire group has a positive refractive power. The term “group having a negative refractive power” means that the entire group has a negative refractive power. The terms “second lens group”, “lens group”, “final lens group”, and “focus group” in the present specification are not limited to a configuration consisting of a plurality of lenses and may be a configuration consisting of only one lens.

A compound aspherical lens (a lens functioning as one aspherical lens as a whole, in which a lens (for example, a spherical lens) and a film of an aspherical shape formed on the lens are configured to be integrated with each other) is not regarded as a cemented lens and is regarded as one lens. Unless otherwise specified, a sign of a refractive power and a surface shape related to a lens including an aspherical surface in a paraxial region are used. For a sign of the curvature radius, a sign of the curvature radius of a surface having a convex shape facing the object side is positive, and a sign of the curvature radius of a surface having a convex shape facing the image side is negative.

In the present specification, the term “entire system” means the zoom lens. The term “focal length” used in the conditional expressions is a paraxial focal length. Unless otherwise specified, the term “distance on the optical axis” used in the conditional expressions is a geometrical distance. Unless otherwise specified, values used in the conditional expressions are values based on the d line in the state where the infinite distance object is in focus.

The terms “d line”, “C line”, “F line”, and “g line” according to the present specification are bright lines. A wavelength of the d line is 587.56 nanometers (nm). A wavelength of the C line is 656.27 nanometers (nm). A wavelength of the F line is 486.13 nanometers (nm). A wavelength of the g line is 435.84 nanometers (nm).

According to the present disclosure, a zoom lens that is configured to be reduced in size and that has a small F number in an entire magnification range and has high optical performance in the entire magnification range, and an imaging apparatus comprising the zoom lens can be provided.

### BRIEF DESCRIPTION OF THE DRAWINGS

FIG. 1 is a diagram that illustrates a cross-sectional view and a moving path of a configuration of a zoom lens according to one embodiment and that corresponds to a zoom lens of Example 1.

FIG. 2 is a diagram for describing symbols of conditional expressions.

FIG. 3 is each aberration diagram of the zoom lens of Example 1.

FIG. 4 is a diagram illustrating a cross-sectional view and a moving path of a configuration of a zoom lens of Example 2.

FIG. 5 is each aberration diagram of the zoom lens of Example 2.

FIG. 6 is a diagram illustrating a cross-sectional view and a moving path of a configuration of a zoom lens of Example 3.

FIG. 7 is each aberration diagram of the zoom lens of Example 3.

FIG. 8 is a diagram illustrating a cross-sectional view and a moving path of a configuration of a zoom lens of Example 4.

FIG. 9 is each aberration diagram of the zoom lens of Example 4.

FIG. 10 is a diagram illustrating a cross-sectional view and a moving path of a configuration of a zoom lens of Example 5.

FIG. 11 is each aberration diagram of the zoom lens of Example 5.

FIG. 12 is a diagram illustrating a cross-sectional view and a moving path of a configuration of a zoom lens of Example 6.

FIG. 13 is each aberration diagram of the zoom lens of Example 6.

FIG. 14 is a diagram illustrating a cross-sectional view and a moving path of a configuration of a zoom lens of Example 7.

FIG. 15 is each aberration diagram of the zoom lens of Example 7.

FIG. 16 is a diagram illustrating a cross-sectional view and a moving path of a configuration of a zoom lens of Example 8.

FIG. 17 is each aberration diagram of the zoom lens of Example 8.

FIG. 18 is a diagram illustrating a cross-sectional view and a moving path of a configuration of a zoom lens of Example 9.

FIG. 19 is each aberration diagram of the zoom lens of Example 9.

FIG. 20 is a diagram illustrating a cross-sectional view and a moving path of a configuration of a zoom lens of Example 10.

FIG. 21 is each aberration diagram of the zoom lens of Example 10.

FIG. 22 is a perspective view of a front surface side of an imaging apparatus according to one embodiment.

FIG. 23 is a perspective view of a rear surface side of the imaging apparatus according to one embodiment.

### DETAILED DESCRIPTION

Hereinafter, an embodiment of the present disclosure will be described with reference to the drawings.

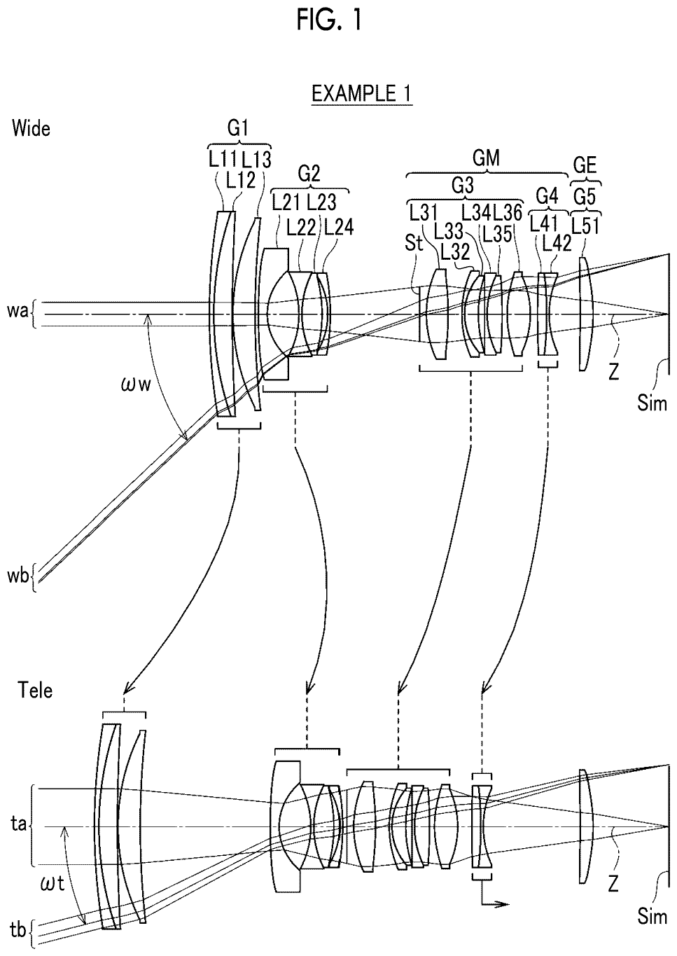

FIG. 1 illustrates a cross-sectional view and a moving path of a configuration of a zoom lens according to one embodiment of the present disclosure. In FIG. 1, a wide angle end state is illustrated in an upper part labeled “Wide”, and a telephoto end state is illustrated in a lower part labeled “Tele”. The example illustrated in FIG. 1 corresponds to a zoom lens of Example 1 described later. FIG. 1 illustrates a state where an infinite distance object is in focus, in which a left side is an object side and a right side is an image side. FIG. 1 also illustrates an on-axis luminous flux wa and a luminous flux wb at a maximum half angle of view ow at a wide angle end and an on-axis luminous flux ta and a luminous flux tb at a maximum half angle of view ωt at a telephoto end.

The zoom lens of the present disclosure consists of, in order from the object side to the image side along an optical axis Z, a first lens group G1 having a positive refractive power, a second lens group G2 having a negative refractive power, an intermediate group GM, and a final lens group GE having a positive refractive power. The intermediate group GM consists of two or three lens groups. Forming the first lens group G1 as a lens group having a positive refractive power can reduce a total length and thus, achieves an advantage in establishing both of reduction in size and a high zoom ratio. In addition, forming the first lens group G1 as a lens group having a positive refractive power reduces a height of a ray incident on the second lens group G2 and thus, achieves an advantage in suppressing fluctuation of aberrations during zooming. Forming the final lens group GE as a lens group having a positive refractive power reduces a height of a ray in the intermediate group GM and thus, achieves an advantage in reducing a diameter of the lens. Forming the intermediate group GM to be configured with two or three lens groups achieves an advantage in establishing both of suppression of fluctuation of the aberrations during the zooming and reduction in size.

During the zooming, a spacing between the first lens group G1 and the second lens group G2 changes, and a spacing between the second lens group G2 and the intermediate group GM changes. In addition, a spacing between the intermediate group GM and the final lens group GE changes, and all spacings between adjacent lens groups in the intermediate group GM change. Changing spacings among a plurality of groups during the zooming achieves an advantage in suppressing various aberrations in an entire magnification range.

In the present specification, one lens group is a group of which a spacing with respect to its adjacent group in an optical axis direction changes during the zooming. During the zooming, a spacing between adjacent lenses does not change in one lens group. That is, the term “lens group” means a part that is a constituent of the zoom lens and that includes at least one lens divided by an air spacing which changes during the zooming. During the zooming, each lens group is moved or fixed in lens group units. The term “lens group” may include a constituent not having a refractive power, for example, an aperture stop St other than a lens.

For example, the zoom lens illustrated in FIG. 1 consists of, in order from the object side to the image side, the first lens group G1, the second lens group G2, a third lens group G3, a fourth lens group G4, and a fifth lens group G5. In the example in FIG. 1, the intermediate group GM consists of the third lens group G3 and the fourth lens group G4, and the final lens group GE consists of the fifth lens group G5.

For example, each lens group in FIG. 1 is configured as follows. The first lens group G1 consists of three lenses including lenses L11 to L13 in order from the object side to the image side. The second lens group G2 consists of four lenses including lenses L21 to L24 in order from the object side to the image side. The third lens group G3 consists of the aperture stop St and six lenses including lenses L31 to L36 in order from the object side to the image side. The fourth lens group G4 consists of two lenses including lenses L41 and L42 in order from the object side to the image side. The fifth lens group G5 consists of one lens that is a lens L51. The aperture stop St in FIG. 1 does not indicate a size or a shape and indicates a position on the optical axis.

In the example in FIG. 1, during the zooming, the first lens group G1, the second lens group G2, the third lens group G3, and the fourth lens group G4 move along the optical axis Z by changing spacings between adjacent lens groups, and the fifth lens group G5 is fixed with respect to an image plane Sim. In FIG. 1, for moving lens groups, an arrow between the upper part and the lower part indicates a schematic moving path of each lens group during the zooming from the wide angle end to the telephoto end.

Moving the first lens group G1 during the zooming achieves an advantage in suppressing fluctuation of the aberrations during the zooming and also achieves an advantage in reduction in size in a state where the zoom lens is accommodated.

Fixing the final lens group GE with respect to the image plane Sim during the zooming achieves an advantage in simplifying a drive mechanism of the lens. However, in the zoom lens of the present disclosure, the final lens group GE may be configured to move during the zooming. Moving the final lens group GE during the zooming achieves an advantage in suppressing fluctuation of the aberrations during the zooming.

In the zoom lens of the present disclosure, the first lens group G1 includes, in consecutive order from a position closest to the object side to the image side, a first lens that is a negative lens having a convex surface on the object side, and a second lens that is a positive lens. This configuration facilitates aberration correction in the first lens group G1 and thus, achieves an advantage in suppressing fluctuation of the aberrations during the zooming. In addition, disposing the negative lens closest to the object side facilitates aberration correction in a case where a focal length at the wide angle end is reduced. In the example in FIG. 1, the lens L11 corresponds to the first lens, and the lens L12 corresponds to the second lens.

The first lens group G1 may be configured to consist of three lenses. Forming the first lens group G1 to be configured with three lenses achieves an advantage in suppression of fluctuation of the aberrations during the zooming and reduction in size. For example, the first lens group G1 can be configured to consist of, in order from the object side to the image side, a negative lens, a positive lens, and a positive lens.

The second lens group G2 may be configured to consist of four lenses. Forming the second lens group G2 to be configured with four lenses achieves an advantage in suppression of fluctuation of the aberrations during the zooming and reduction in size. For example, the second lens group G2 may be configured to consist of, in order from the object side to the image side, a negative lens, a negative lens, a positive lens, and a negative lens.

The aperture stop St is disposed between a lens surface of the second lens group G2 closest to the image side and a lens surface of the final lens group GE closest to the object side. This configuration enables reduction of a stop unit in size and thus, achieves an advantage in reduction of an entire lens system in size.

For example, the aperture stop St may be disposed closest to the object side in the intermediate group GM. Doing so can bring the aperture stop St and the first lens group G1 close to each other and thus, can reduce a distance from a lens surface of the first lens group G1 closest to the object side to an entrance pupil position. This achieves an advantage in reducing a diameter of the first lens group G1.

The zoom lens of the present disclosure may be configured to include a focus group that moves along the optical axis Z during focusing. Focusing is performed by moving the focus group. In the example in FIG. 1, the focus group consists of the fourth lens group G4. A bracket and a rightward arrow under the fourth lens group G4 in FIG. 1 indicate that the fourth lens group G4 is the focus group that moves to the image side during focusing from the infinite distance object to a nearest object. While the fourth lens group G4 functions as a focus group in the entire magnification range, the bracket and the arrow indicating the focus group are provided in only the lower part of FIG. 1 in order to avoid complication of the drawing.

The focus group may be configured to consist of one cemented lens. Doing so can reduce the number of lenses of the focus group. This can simplify a mechanism for controlling the focus group and facilitates quick focusing.

In a case where the focus group consists of one cemented lens, the cemented lens may be configured to consist of a positive lens and a negative lens in order from the object side to the image side. Doing so achieves an advantage in suppressing fluctuation of the aberrations during the focusing.

The zoom lens of the present disclosure may be configured not to include a lens that moves for image shake correction. Doing so can simplify a mechanism of the lens.

The zoom lens may be configured to include 14 or more lenses as a whole. Doing so achieves an advantage in suppressing various aberrations.

Next, preferable configurations related to conditional expressions of the zoom lens of the present disclosure will be described. In the following description related to the conditional expressions, in order to avoid redundant description, the same symbol will be used for the same definition to partially omit duplicate descriptions of the symbol. Hereinafter, the “zoom lens of the present disclosure” will be simply referred to as the “zoom lens” in order to avoid redundant description.

The zoom lens preferably satisfies Conditional Expression (1). A focal length of the entire system in a state where the infinite distance object is in focus at the wide angle end is denoted by fw. A focal length of the first lens group G1 is denoted by f1. For a lower limit value of Conditional Expression (1), 0<fw/f1 is established because the first lens group G1 is a lens group having a positive refractive power. Ensuring that a corresponding value of Conditional Expression (1) is not greater than or equal to its upper limit value prevents an excessively strong refractive power of the first lens group G1 and thus, achieves an advantage in suppressing fluctuation of the aberrations during the zooming.

$$0 < fw / f 1 < 0.3 \qquad ( 1 )$$

The lower limit value of Conditional Expression (1) is more preferably 0.05. Doing so prevents an excessively weak refractive power of the first lens group G1 and thus, achieves an advantage in reduction of the first lens group G1 in size. In order to obtain more favorable characteristics, the lower limit value of Conditional Expression (1) is further preferably 0.1, further preferably 0.12, and further preferably 0.15. In order to obtain more favorable characteristics, the upper limit value of Conditional Expression (1) is more preferably 0.25, further preferably 0.2, further preferably 0.19, and further preferably 0.18. For example, the zoom lens more preferably satisfies Conditional Expression (1-1).

$$0 \text{.1} < fw / f 1 < 0.2 \qquad ( 1 - 1 )$$

The zoom lens preferably satisfies Conditional Expression (2). An open F-number in a state where the infinite distance object is in focus at the telephoto end is denoted by Fnot. A focal length of the entire system in the state where the infinite distance object is in focus at the telephoto end is denoted by ft. Ensuring that a corresponding value of Conditional Expression (2) is not less than or equal to its lower limit value achieves an advantage in reduction of the entire lens system in size or an advantage in particularly suppressing various aberrations at the telephoto end. Ensuring that the corresponding value of Conditional Expression (2) is not greater than or equal to its upper limit value facilitates maintaining of a small F-number at the telephoto end and thus, achieves an advantage in obtaining sufficient brightness at the telephoto end.

$$0.5 < Fnot / ( ft / fw ) < 1.3 \qquad ( 2 )$$

In order to obtain more favorable characteristics, the lower limit value of Conditional Expression (2) is more preferably 0.6, further preferably 0.7, further preferably 0.8, and further preferably 0.85. In order to obtain more favorable characteristics, the upper limit of Conditional Expression (2) is more preferably 1.2 and further preferably 1.1.

The zoom lens preferably satisfies Conditional Expression (3). A back focus of the entire system as an air conversion distance at the wide angle end is denoted by Bfw. A maximum half angle of view in the state where the infinite distance object is in focus on at the telephoto end is denoted by ωt. Here, tan denotes a tangent. The term “back focus of the entire system as the air conversion distance” means an air conversion distance on the optical axis from a lens surface of the entire system closest to the image side to the image plane Sim. Ensuring that a corresponding value of Conditional Expression (3) is not less than or equal to its lower limit value prevents an excessively short back focus and thus, facilitates attachment of a mount replacement mechanism. Ensuring that the corresponding value of Conditional Expression (3) is not greater than or equal to its upper limit prevents an excessively long back focus and thus, facilitates reduction in size.

$$0.15 < Bfw / ( ft \times tan ω t ) < 2 \qquad ( 3 )$$

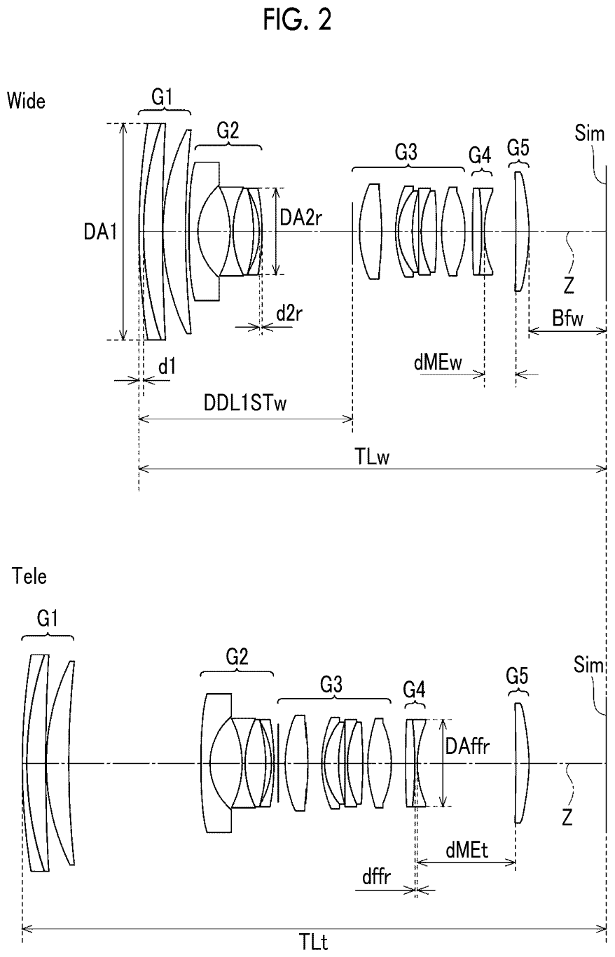

FIG. 2 illustrates a cross-sectional view of the zoom lens in FIG. 1 and, for example, illustrates the back focus Bfw in the zoom lens. In FIG. 2, the wide angle end state is illustrated in an upper part labeled “Wide”, and the telephoto end state is illustrated in a lower part labeled “Tele”.

In order to obtain more favorable characteristics, the lower limit value of Conditional Expression (3) is more preferably 0.2, further preferably 0.25, further preferably 0.3, and further preferably 0.35. In order to obtain more favorable characteristics, the upper limit value of Conditional Expression (3) is more preferably 1.7, further preferably 1.6, further preferably 1.5, and further preferably 1.4.

The zoom lens preferably satisfies Conditional Expression (4). A sum of the back focus of the entire system as the air conversion distance and a distance on the optical axis from a surface of the first lens on the object side to a lens surface of the final lens group GE closest to the image side in the state where the infinite distance object is in focus at the telephoto end is denoted by TLt. TLt denotes the total length in the state where the infinite distance object is in focus at the telephoto end. For example, FIG. 2 illustrates the total length TLt. Ensuring that a corresponding value of Conditional Expression (4) is not less than or equal to its lower limit value can cause the on-axis luminous flux ta to gradually converge to the image plane Sim at the telephoto end and thus, can suppress an axial chromatic aberration that occurs during converging of the on-axis luminous flux ta. Ensuring that the corresponding value of Conditional Expression (4) is not greater than or equal to its upper limit value facilitates reduction of the total length TLt at the telephoto end.

$$7 < TLt / ( ft \times tan ω t ) < 11 \qquad ( 4 )$$

In order to obtain more favorable characteristics, the lower limit value of Conditional Expression (4) is more preferably 7.5, further preferably 8, further preferably 8.5, and further preferably 9. In order to obtain more favorable characteristics, the upper limit value of Conditional Expression (4) is more preferably 10.5.

The zoom lens preferably satisfies Conditional Expression (5). A spacing on the optical axis between the intermediate group GM and the final lens group GE in the state where the infinite distance object is in focus at the telephoto end is denoted by dMEt. A spacing on the optical axis between the intermediate group GM and the final lens group GE in the state where the infinite distance object is in focus at the wide angle end is denoted by dMEw. For example, FIG. 2 illustrates the spacing dMEt and the spacing dMEw. Ensuring that a corresponding value of Conditional Expression (5) is not less than or equal to its lower limit value achieves an advantage in suppressing fluctuation of the aberrations during the zooming. Ensuring that the corresponding value of Conditional Expression (5) is not greater than or equal to its upper limit value achieves an advantage in reduction of the total length.

$$2 < dMEt / dMEw < 10. \qquad ( 5 )$$

In order to obtain more favorable characteristics, the lower limit value of Conditional Expression (5) is more preferably 2.2, further preferably 2.5, further preferably 2.8, and further preferably 3. In order to obtain more favorable characteristics, the upper limit value of Conditional Expression (5) is more preferably 9, further preferably 8, further preferably 7, and further preferably 6.

The zoom lens preferably satisfies Conditional Expression (6). A paraxial curvature radius of a lens surface of the second lens group G2 closest to the object side is denoted by R2f. A paraxial curvature radius of a lens surface of the second lens group G2 closest to the image side is denoted by R2r. Ensuring that a corresponding value of Conditional Expression (6) is not less than or equal to its lower limit value achieves an advantage in suppressing a spherical aberration at the telephoto end. Ensuring that the corresponding value of Conditional Expression (6) is not greater than or equal to its upper limit value achieves an advantage in suppressing the aberrations for each image height at the wide angle end.

$$- 0.5 < ( R 2 f + R 2 r ) / ( R 2 f - R 2 r ) < 2 \qquad ( 6 )$$

In order to obtain more favorable characteristics, the lower limit value of Conditional Expression (6) is more preferably −0.2, further preferably 0.15, further preferably 0.2, and further preferably 0.3. In order to obtain more favorable characteristics, the upper limit value of Conditional Expression (6) is more preferably 1.5, further preferably 1, further preferably 0.9, and further preferably 0.85.

In a case where a refractive index with respect to a d line for a lens closest to the image side in the first lens group G1 is denoted by Nd1r, the zoom lens preferably satisfies Conditional Expression (7). Ensuring that a corresponding value of Conditional Expression (7) is not less than or equal to its lower limit value achieves an advantage in reduction of the first lens group G1 in size. Ensuring that the corresponding value of Conditional Expression (7) is not greater than or equal to its upper limit value achieves an advantage in suppressing a field curvature at the wide angle end.

$$1.65 < Nd 1 r < 1.8 \qquad ( 7 )$$

In order to obtain more favorable characteristics, the lower limit value of Conditional Expression (7) is more preferably 1.67, further preferably 1.68, further preferably 1.69, and further preferably 1.7. In order to obtain more favorable characteristics, the upper limit value of Conditional Expression (7) is more preferably 1.78, further preferably 1.77, further preferably 1.76, and further preferably 1.75.

In a case where an Abbe number based on the d line for the lens closest to the image side in the first lens group G1 is denoted by vd1r, the zoom lens preferably satisfies Conditional Expression (8). Ensuring that a corresponding value of Conditional Expression (8) is not less than or equal to its lower limit value achieves an advantage in suppressing a lateral chromatic aberration at the wide angle end. Ensuring that the corresponding value of Conditional Expression (8) is not greater than or equal to its upper limit value prevents an excessively low refractive index and thus, achieves an advantage in reduction of the first lens group G1 in size.

$$45 < vd 1 r < 60 \qquad ( 8 )$$

In order to obtain more favorable characteristics, the lower limit value of Conditional Expression (8) is more preferably 47, further preferably 49, further preferably 51, and further preferably 53. In order to obtain more favorable characteristics, the upper limit value of Conditional Expression (8) is more preferably 59, further preferably 58, further preferably 57, and further preferably 56.

In a case where a refractive index with respect to a d line for a lens closest to the image side in the second lens group G2 is denoted by Nd2r, the zoom lens preferably satisfies Conditional Expression (9). Ensuring that a corresponding value of Conditional Expression (9) is not less than or equal to its lower limit value achieves an advantage in reduction of the second lens group G2 in size. Ensuring that the corresponding value of Conditional Expression (9) is not greater than or equal to its upper limit value achieves an advantage in suppressing the field curvature at the wide angle end.

$$1.4 < Nd 2 r < 1 \text{.65} \qquad ( 9 )$$

In order to obtain more favorable characteristics, the upper limit value of Conditional Expression (9) is more preferably 1.6, further preferably 1.58, further preferably 1.55, and further preferably 1.5.

In a case where an Abbe number based on the d line for the lens closest to the image side in the second lens group G2 is denoted by vd2r, the zoom lens preferably satisfies Conditional Expression (10). Ensuring that a corresponding value of Conditional Expression (10) is not less than or equal to its lower limit value achieves an advantage in suppressing a chromatic coma at the wide angle end. Ensuring that the corresponding value of Conditional Expression (10) is not greater than or equal to its upper limit value prevents an excessively low refractive index and thus, achieves an advantage in reduction of the second lens group G2 in size.

$$60 < vd 2 r < 100 \qquad ( 10 )$$

In order to obtain more favorable characteristics, the lower limit value of Conditional Expression (10) is more preferably 65, further preferably 70, further preferably 75, and further preferably 80.

The zoom lens more preferably satisfies Conditional Expressions (7), (8), (9), and (10) at the same time.

The zoom lens preferably satisfies Conditional Expression (11). Ensuring that a corresponding value of Conditional Expression (11) is not less than or equal to its lower limit value achieves an advantage in suppressing various aberrations. Ensuring that the corresponding value of Conditional Expression (11) is not greater than or equal to its upper limit value achieves an advantage in obtaining a wide angle of view at the wide angle end.

$$1 < fw / ( ft \times tan ω t ) < 1.45 \qquad ( 11 )$$

In order to obtain more favorable characteristics, the lower limit value of Conditional Expression (11) is more preferably 1.05 and further preferably 1.1. In order to obtain more favorable characteristics, the upper limit value of Conditional Expression (11) is more preferably 1.4, further preferably 1.35, further preferably 1.3, and further preferably 1.25.

The zoom lens preferably satisfies Conditional Expression (12). A distance on the optical axis from the surface of the first lens on the object side to the aperture stop St in the state where the infinite distance object is in focus at the wide angle end is denoted by DDL1STw. A sum of the back focus of the entire system as the air conversion distance and a distance on the optical axis from the surface of the first lens on the object side to the lens surface of the final lens group GE closest to the image side in the state where the infinite distance object is in focus at the wide angle end is denoted by TLw. TLw denotes the total length in the state where the infinite distance object is in focus at the wide angle end. For example, FIG. 2 illustrates the distance DDL1STw and the total length TLw. Ensuring that a corresponding value of Conditional Expression (12) is not less than or equal to its lower limit value prevents an excessively short distance between the aperture stop St and the first lens group G1 and thus, also prevents an excessively short distance from the surface of the first lens on the object side to the entrance pupil position. This facilitates suppression of fluctuation of the aberrations during the zooming. Ensuring that the corresponding value of Conditional Expression (12) is not greater than or equal to its upper limit value prevents an excessively long distance between the aperture stop St and the first lens group G1 and thus, prevents an excessively long distance from the surface of the first lens on the object side to the entrance pupil position. This can suppress an increase in the diameter of the first lens group G1 and thus, facilitates reduction in size.

$$0 < DDL 1 STw / TLw < 0 \text{.65} \qquad ( 12 )$$

In order to obtain more favorable characteristics, the lower limit value of Conditional Expression (12) is more preferably 0.05, further preferably 0.1, further preferably 0.15, and further preferably 0.2. In order to obtain more favorable characteristics, the upper limit value of Conditional Expression (12) is more preferably 0.6, further preferably 0.55, further preferably 0.5, and further preferably 0.46.

The zoom lens preferably satisfies Conditional Expression (13). A center thickness of the first lens is denoted by d1. An outer diameter of the first lens is denoted by DA1. For example, FIG. 2 illustrates the center thickness d1 and the outer diameter DA1. Ensuring that a corresponding value of Conditional Expression (13) is not less than or equal to its lower limit value achieves an advantage in processing accuracy of the lens. Ensuring that the corresponding value of Conditional Expression (13) is not greater than or equal to its upper limit value achieves an advantage in reduction of the first lens group G1 in size.

$$0.01 < d 1 / DA 1 < 0 \text{.035} \qquad ( 13 )$$

In order to obtain more favorable characteristics, the lower limit value of Conditional Expression (13) is more preferably 0.013, further preferably 0.015, further preferably 0.017, and further preferably 0.019. In order to obtain more favorable characteristics, the upper limit value of Conditional Expression (13) is more preferably 0.03, further preferably 0.028, further preferably 0.025, and further preferably 0.023.

The zoom lens preferably satisfies Conditional Expression (14). A center thickness of a negative lens closest to the image side among negative lenses included in the second lens group G2 is denoted by d2r. An outer diameter of the negative lens closest to the image side among the negative lenses included in the second lens group G2 is denoted by DA2r. For example, FIG. 2 illustrates the center thickness d2r and the outer diameter DA2r. Ensuring that a corresponding value of Conditional Expression (14) is not less than or equal to its lower limit value achieves an advantage in the processing accuracy of the lens. Ensuring that the corresponding value of Conditional Expression (14) is not greater than or equal to its upper limit value achieves an advantage in reduction of the second lens group G2 in size.

$$0.01 < d 2 r / DA 2 r < 0 \text{.04} \qquad ( 14 )$$

In order to obtain more favorable characteristics, the lower limit value of Conditional Expression (14) is more preferably 0.013, further preferably 0.015, further preferably 0.017, and further preferably 0.019. In order to obtain more favorable characteristics, the upper limit value of Conditional Expression (14) is more preferably 0.038, further preferably 0.035, further preferably 0.032, and further preferably 0.03.

In a configuration in which the zoom lens includes the focus group that moves along the optical axis Z during the focusing, and the focus group includes at least one negative lens, the zoom lens preferably satisfies Conditional Expression (15). A center thickness of a negative lens closest to the image side among negative lenses included in the focus group is denoted by dffr. An outer diameter of the negative lens closest to the image side among the negative lenses included in the focus group is denoted by DAffr. For example, FIG. 2 illustrates the center thickness dffr and the outer diameter DAffr. Ensuring that a corresponding value of Conditional Expression (15) is not less than or equal to its lower limit value achieves an advantage in the processing accuracy of the lens. Ensuring that the corresponding value of Conditional Expression (15) is not greater than or equal to its upper limit value achieves an advantage in reduction of the focus group in size.

$$0.01 < dffr / DAffr < 0.04 \qquad ( 15 )$$

In order to obtain more favorable characteristics, the lower limit value of Conditional Expression (15) is more preferably 0.013, further preferably 0.015, further preferably 0.017, and further preferably 0.019. In order to obtain more favorable characteristics, the upper limit value of Conditional Expression (15) is more preferably 0.038, further preferably 0.035, further preferably 0.032, and further preferably 0.03.

In a case where a focal length of the final lens group GE is denoted by fE, the zoom lens preferably satisfies Conditional Expression (16). For a lower limit value of Conditional Expression (16), 0<f1/fE is established because the first lens group G1 and the final lens group GE are lens groups having a positive refractive power. Ensuring that a corresponding value of Conditional Expression (16) is not greater than or equal to its upper limit value prevents an excessively strong refractive power of the final lens group GE and thus, achieves an advantage in reduction in size. In addition, doing so prevents an excessively weak refractive power of the first lens group G1 and thus, achieves an advantage in reduction of the first lens group G1 in size.

$$0 < f 1 / fE < 2 \qquad ( 16 )$$

The lower limit value of Conditional Expression (16) is more preferably 0.1. Doing so prevents an excessively weak refractive power of the final lens group GE and thus, achieves an advantage in suppressing the aberrations for each image height. In addition, doing so prevents an excessively strong refractive power of the first lens group G1 and thus, achieves an advantage in suppressing fluctuation of the aberrations during the zooming. In order to obtain more favorable characteristics, the lower limit value of Conditional Expression (16) is further preferably 0.2, further preferably 0.4, and further preferably 0.6. In order to obtain more favorable characteristics, the upper limit value of Conditional Expression (16) is more preferably 1.8, further preferably 1.5, further preferably 1.2, and further preferably 1.

In a case where a focal length of the second lens group G2 is denoted by f2, the zoom lens preferably satisfies Conditional Expression (17). Ensuring that a corresponding value of Conditional Expression (17) is not less than or equal to its lower limit value prevents an excessively strong refractive power of the second lens group G2 and thus, achieves an advantage in suppressing fluctuation of the aberrations during the zooming. Ensuring that the corresponding value of Conditional Expression (17) is not greater than or equal to its upper limit value prevents an excessively weak refractive power of the second lens group G2 and thus, achieves an advantage in reduction in size.

$$- 2 < fw / f 2 < - 0.7 \qquad ( 17 )$$

In order to obtain more favorable characteristics, the lower limit value of Conditional Expression (17) is more preferably −1.8, further preferably −1.5, further preferably −1.3, and further preferably −1. In order to obtain more favorable characteristics, the upper limit value of Conditional Expression (17) is more preferably −0.75, further preferably −0.8, further preferably −0.85, and further preferably −0.9.

In a configuration in which the zoom lens includes the focus group that moves along the optical axis Z during the focusing, the zoom lens preferably satisfies Conditional Expression (18). A focal length of the focus group is denoted by ff. Ensuring that a corresponding value of Conditional Expression (18) is not less than or equal to its lower limit value prevents an excessively weak refractive power of the focus group and thus, achieves an advantage in reduction in size. In addition, doing so prevents an excessively strong refractive power of the second lens group G2 and thus, achieves an advantage in suppressing fluctuation of the aberrations during the zooming. Ensuring that the corresponding value of Conditional Expression (18) is not greater than or equal to its upper limit value prevents an excessively strong refractive power of the focus group and thus, can suppress strictness of stopping position accuracy. In addition, doing so prevents an excessively weak refractive power of the second lens group G2 and thus, achieves an advantage in reduction in size.

$$0.2 < f2 / ff < 0.8 \qquad ( 18 )$$

In order to obtain more favorable characteristics, the lower limit value of Conditional Expression (18) is more preferably 0.25, further preferably 0.3, further preferably 0.35, and further preferably 0.4. In order to obtain more favorable characteristics, the upper limit value of Conditional Expression (18) is more preferably 0.75, further preferably 0.7, further preferably 0.65, and further preferably 0.6.

The zoom lens preferably satisfies Conditional Expression (19). Hereinafter, a lens group having the strongest positive refractive power among the lens groups included in the intermediate group GM will be referred to as an Mp lens group. A focal length of the Mp lens group is denoted by fMp. Ensuring that a corresponding value of Conditional Expression (19) is not less than or equal to its lower limit value prevents an excessively weak refractive power of the Mp lens group and thus, achieves an advantage in reduction in size. Ensuring that the corresponding value of Conditional Expression (19) is not greater than or equal to its upper limit value prevents an excessively strong refractive power of the Mp lens group and thus, achieves an advantage in suppressing fluctuation of the aberrations during the zooming.

$$0.4 < fw / fMp < 2 \qquad ( 19 )$$

In order to obtain more favorable characteristics, the lower limit value of Conditional Expression (19) is more preferably 0.45, further preferably 0.5, further preferably 0.55, and further preferably 0.6. In order to obtain more favorable characteristics, the upper limit value of Conditional Expression (19) is more preferably 1.5, further preferably 1.3, further preferably 1, and further preferably 0.8.

The zoom lens preferably satisfies Conditional Expression (20). Ensuring that a corresponding value of Conditional Expression (20) is not less than or equal to its lower limit value prevents an excessively weak refractive power of the Mp lens group and thus, achieves an advantage in reduction in size. Ensuring that the corresponding value of Conditional Expression (20) is not greater than or equal to its upper limit value prevents an excessively strong refractive power of the Mp lens group and thus, achieves an advantage in suppressing fluctuation of the aberrations during the zooming.

$$1.5 < ft / fMp < 5 \qquad ( 20 )$$

In order to obtain more favorable characteristics, the lower limit value of Conditional Expression (20) is more preferably 2, further preferably 2.2, further preferably 2.3, and further preferably 2.4. In order to obtain more favorable characteristics, the upper limit value of Conditional Expression (20) is more preferably 4.5, further preferably 4, further preferably 3.5, and further preferably 3.

In a configuration in which the Mp lens group includes one or more cemented lenses, the zoom lens preferably satisfies Conditional Expression (21). A refractive index with respect to a d line for a positive lens included in a cemented lens closest to the object side among cemented lenses included in the Mp lens group is denoted by Ndfp. A refractive index with respect to a d line for a negative lens included in the cemented lens closest to the object side among the cemented lenses included in the Mp lens group is denoted by Ndfn. Satisfying Conditional Expression (21) achieves an advantage in correcting a first-order spectrum of the axial chromatic aberration.

$$- 0 \text{.7} < Ndfp - Ndfn < - 0.2 \qquad ( 21 )$$

In order to obtain more favorable characteristics, the lower limit value of Conditional Expression (21) is more preferably −0.65, further preferably −0.6, further preferably −0.5, and further preferably −0.45. In order to obtain more favorable characteristics, the upper limit value of Conditional Expression (21) is more preferably −0.25, further preferably −0.3, further preferably −0.35, and further preferably −0.4.

In the configuration in which the Mp lens group includes one or more cemented lenses, the zoom lens preferably satisfies Conditional Expression (22). An Abbe number based on the d line for the positive lens included in the cemented lens closest to the object side among the cemented lenses included in the Mp lens group is denoted by vdfp. An Abbe number based on the d line for the negative lens included in the cemented lens closest to the object side among the cemented lenses included in the Mp lens group is denoted by vdfn. Satisfying Conditional Expression (22) achieves an advantage in correcting the first-order spectrum of the axial chromatic aberration.

$$30 < vdfp - vdfn < 100 \qquad ( 22 )$$

In order to obtain more favorable characteristics, the lower limit value of Conditional Expression (22) is more preferably 35, further preferably 40, further preferably 50, and further preferably 60. In order to obtain more favorable characteristics, the upper limit value of Conditional Expression (22) is more preferably 90, further preferably 80, and further preferably 70.

In the configuration in which the Mp lens group includes one or more cemented lenses, the zoom lens preferably satisfies Conditional Expression (23). A partial dispersion ratio between a g line and an F line for the positive lens included in the cemented lens closest to the object side among the cemented lenses included in the Mp lens group is denoted by θgFfp. A partial dispersion ratio between a g line and an F line for the negative lens included in the cemented lens closest to the object side among the cemented lenses included in the Mp lens group is denoted by θgFfn. Satisfying Conditional Expression (23) achieves an advantage in correcting a second-order spectrum of the axial chromatic aberration.

$$- 0.12 < θ gFfn - θ gFfn < - 0.02 \qquad ( 23 )$$

In a case where refractive indices with respect to a g line, an F line, and a C line for a lens are denoted by Ng, NF, and NC, respectively, and a partial dispersion ratio between the g line and the F line for the lens is denoted by θgF, θgF is defined as the following expression.

$$θ g F = ( Ng - NF ) / ( NF - NC )$$

In order to obtain more favorable characteristics, the lower limit value of Conditional Expression (23) is more preferably −0.11, further preferably −0.1, further preferably −0.09, and further preferably −0.08. In order to obtain more favorable characteristics, the upper limit value of Conditional Expression (23) is more preferably −0.03, further preferably −0.04, further preferably −0.05, and further preferably −0.06.

The zoom lens more preferably satisfies Conditional Expressions (21), (22), and (23) at the same time.

In a case where the cemented lens closest to the object side includes a plurality of positive lenses, Conditional Expressions (21), (22), and (23) are calculated using values of a positive lens closest to the object side included in the cemented lens. In a case where the cemented lens closest to the object side includes a plurality of negative lenses, Conditional Expressions (21), (22), and (23) are calculated using values of a negative lens closest to the object side included in the cemented lens.

In the configuration in which the Mp lens group includes one or more cemented lenses, the zoom lens preferably satisfies Conditional Expression (24). A refractive index with respect to a d line for a positive lens included in a cemented lens closest to the image side among the cemented lenses included in the Mp lens group is denoted by Ndrp. A refractive index with respect to a d line for a negative lens included in the cemented lens closest to the image side among the cemented lenses included in the Mp lens group is denoted by Ndrn. Satisfying Conditional Expression (24) achieves an advantage in correcting the first-order spectrum of the axial chromatic aberration.

$$- 0 \text{.7} < Ndrp - Ndrn < - 0.1 \qquad ( 24 )$$

In order to obtain more favorable characteristics, the lower limit value of Conditional Expression (24) is more preferably −0.65, further preferably −0.6, further preferably −0.5, and further preferably −0.4. In order to obtain more favorable characteristics, the upper limit value of Conditional Expression (24) is more preferably −0.15, further preferably −0.2, further preferably −0.25, and further preferably −0.3.

In the configuration in which the Mp lens group includes one or more cemented lenses, the zoom lens preferably satisfies Conditional Expression (25). An Abbe number based on the d line for the positive lens included in the cemented lens closest to the image side among the cemented lenses included in the Mp lens group is denoted by vdrp. An Abbe number based on the d line for the negative lens included in the cemented lens closest to the image side among the cemented lenses included in the Mp lens group is denoted by vdrn. Satisfying Conditional Expression (25) achieves an advantage in correcting the first-order spectrum of the axial chromatic aberration.

$$30 < vdrp - vdrn < 100 \qquad ( 25 )$$

In order to obtain more favorable characteristics, the lower limit value of Conditional Expression (25) is more preferably 35, further preferably 40, further preferably 45, and further preferably 50. In order to obtain more favorable characteristics, the upper limit value of Conditional Expression (25) is more preferably 90, further preferably 80, further preferably 70, and further preferably 60.

In the configuration in which the Mp lens group includes one or more cemented lenses, the zoom lens preferably satisfies Conditional Expression (26). A partial dispersion ratio between a g line and an F line for the positive lens included in the cemented lens closest to the image side among the cemented lenses included in the Mp lens group is denoted by θgFrp. A partial dispersion ratio between a g line and an F line for the negative lens included in the cemented lens closest to the image side among the cemented lenses included in the Mp lens group is denoted by θgFrn. Satisfying Conditional Expression (26) achieves an advantage in correcting the second-order spectrum of the axial chromatic aberration.

$$- 0.12 < θ gFrp - θ gFrn < - 0.02 \qquad ( 26 )$$

In order to obtain more favorable characteristics, the lower limit value of Conditional Expression (26) is more preferably −0.11, further preferably −0.1, further preferably −0.09, and further preferably −0.08. In order to obtain more favorable characteristics, the upper limit value of Conditional Expression (26) is more preferably −0.03, further preferably −0.04, further preferably −0.05, and further preferably −0.06.

The zoom lens more preferably satisfies Conditional Expressions (24), (25), and (26) at the same time.

In a case where the cemented lens closest to the image side includes a plurality of positive lenses, Conditional Expressions (24), (25), and (26) are calculated using values of a positive lens closest to the image side included in the cemented lens. In a case where the cemented lens closest to the image side includes a plurality of negative lenses, Conditional Expressions (24), (25), and (26) are calculated using values of a negative lens closest to the image side included in the cemented lens.

The example illustrated in FIG. 1 is merely an example, and various modifications can be made without departing from the gist of the disclosed technology. For example, the number of lens groups included in the intermediate group GM and the number of lenses included in each lens group may be different from the numbers in the example in FIG. 1.

The zoom lens of the example illustrated in FIG. 1 consists of, in order from the object side to the image side, the first lens group G1 having a positive refractive power, the second lens group G2 having a negative refractive power, the third lens group G3 having a positive refractive power, the fourth lens group G4 having a negative refractive power, and the fifth lens group G5 having a positive refractive power. Such a configuration achieves an advantage in reduction in size and weight.

However, as will be illustrated in the examples described later, the zoom lens of the present disclosure may be configured to consist of, in order from the object side to the image side, the first lens group G1 having a positive refractive power, the second lens group G2 having a negative refractive power, the third lens group G3 having a positive refractive power, the fourth lens group G4 having a positive refractive power, the fifth lens group G5 having a negative refractive power, and a sixth lens group G6 having a positive refractive power. Such a configuration achieves an advantage in suppressing fluctuation of the aberrations during the zooming.

The preferable configurations and available configurations described above can be combined in any manner without inconsistency and are preferably selectively adopted, as appropriate, in accordance with required specifications.

For example, according to a preferable aspect of the zoom lens of the present disclosure, the zoom lens consists of, in order from the object side to the image side, the first lens group G1 having a positive refractive power, the second lens group G2 having a negative refractive power, the intermediate group GM, and the final lens group GE having a positive refractive power, in which the intermediate group GM consists of two or three lens groups, during the zooming, the spacing between the first lens group G1 and the second lens group G2 changes, the spacing between the second lens group G2 and the intermediate group GM changes, the spacing between the intermediate group GM and the final lens group GE changes, and all spacings between the adjacent lens groups in the intermediate group GM change, the aperture stop St is disposed between the lens surface of the second lens group G2 closest to the image side and the lens surface of the final lens group GE closest to the object side, the first lens group G1 includes, in consecutive order from a position closest to the object side to the image side, the first lens that is a negative lens having a convex surface on the object side, and the second lens that is a positive lens, and Conditional Expressions (1), (2), (3), and (4) are satisfied.

Next, examples of the zoom lens of the present disclosure will be described with reference to the drawings. Reference numerals provided to each lens and each group in the cross-sectional view of each example are independently used for each example in order to avoid complication of description and the drawings caused by an increasing number of digits of the reference numerals. Accordingly, even in a case where a common reference numeral is provided in the drawings of different examples, the common reference numeral does not necessarily indicate a common configuration.

### Example 1

A configuration and a moving path of the zoom lens of Example 1 are illustrated in FIG. 1, and its illustration method and configuration are the same as described above. Thus, duplicate descriptions will be partially omitted. The zoom lens of Example 1 consists of, in order from the object side to the image side, the first lens group G1 having a positive refractive power, the second lens group G2 having a negative refractive power, the third lens group G3 having a positive refractive power, the fourth lens group G4 having a negative refractive power, and the fifth lens group G5 having a positive refractive power. The intermediate group GM consists of the third lens group G3 and the fourth lens group G4. The final lens group GE consists of the fifth lens group G5. During the zooming from the wide angle end to the telephoto end, the first lens group G1, the second lens group G2, the third lens group G3, and the fourth lens group G4 move along the optical axis Z by changing spacings between adjacent lens groups, and the fifth lens group G5 is fixed with respect to the image plane Sim. The focus group consists of the fourth lens group G4. During the focusing from the infinite distance object to the nearest object, the focus group moves to the image side.

For the zoom lens of Example 1, Table 1 shows basic lens data, Table 2 shows specifications and a variable surface spacing, and Table 3 shows aspherical coefficients.

The table of the basic lens data is described as follows. A column of “Sn” shows surface numbers in a case where the number is increased by one at a time toward the image side from the surface closest to the object side as a first surface. A column of “R” shows a curvature radius of each surface. A column of “D” shows a surface spacing on the optical axis between each surface and its adjacent surface on the image side. A column of “Nd” shows a refractive index with respect to the d line for each lens. A column of “vd” shows an Abbe number based on the d line for each lens. A column of “θgF” shows a partial dispersion ratio between the g line and the F line for each constituent. A column of “DA” shows an outer diameter. The column of “DA” shows values for only the lenses related to the conditional expressions.

In the table of the basic lens data, a sign of the curvature radius of the surface having a convex shape facing the object side is positive, and a sign of the curvature radius of the surface having a convex shape facing the image side is negative. In Table 1, a field of the surface number of the surface corresponding to the aperture stop St has the surface number and a text (St). A value in the lowermost field of the column of D in the table indicates a spacing between the surface closest to the image side in the table and the image plane Sim. A symbol DD[ ] is used for the variable surface spacing during the zooming. A surface number on the object side of the spacing is provided in [ ] in the column of the surface spacing.

Table 2 shows a zoom ratio Zr, a focal length f, a back focus Bf, an open F-number FNo., a maximum full angle of view 2ω, and the variable surface spacing based on the d line. The zoom ratio is synonymous with a zoom magnification. In a field of 2ω, [°] indicates a degree unit. Table 2 shows each value of the wide angle end state, a middle focal length state, and the telephoto end state in columns labeled “Wide”, “Middle”, and “Tele”, respectively.

In the basic lens data, a surface number of an aspherical surface is marked with *, and a value of a paraxial curvature radius is shown in a field of the curvature radius of the aspherical surface. In Table 3, the column of Sn shows the surface number of the aspherical surface, and columns of KA and Am (m=3, 4, 5, 6, 7, 8, 9, and 10) show a numerical value of the aspherical coefficient for each aspherical surface. In the numerical value of the aspherical coefficient in Table 3, “E±n” (n: integer) means “×10^{±n}”. KA and Am are aspherical coefficients in an aspheric equation represented by the following expression.

$$Zd = C \times {h}^{2} / \{ 1 + {( 1 - KA \times {C}^{2} \times {h}^{2} )}^{1 / 2} \} + \sum Am \times {h}^{m}$$

where
Zd: an aspherical depth (a length of a perpendicular line drawn from a point on an aspherical surface at a height h to a plane that is in contact with an aspherical surface apex and that is perpendicular to the optical axis Z)
h: a height (a distance from the optical axis Z to a lens surface)
C: a reciprocal of a paraxial curvature radius
KA and Am: aspherical coefficients
Σ in the aspheric equation means a sum total related to m.

In the data of each table, a degree unit is used for angles, and a millimeter unit is used for lengths. However, since the optical system can also be proportionally enlarged or proportionally reduced to be used, other appropriate units can also be used. Numerical values rounded to predetermined digits are described in each table shown below.

TABLE 1
Example 1

| Sn | R | D | Nd | νd | θgF | DA |
|---|---|---|---|---|---|---|
| 1 | 156.6331 | 1.0500 | 1.84666 | 23.79 | 0.62056 | 52.4 |
| 2 | 79.0465 | 4.3500 | 1.49700 | 81.55 | 0.53837 | |
| 3 | 439.4315 | 0.1500 | | | | |
| 4 | 52.9012 | 5.2300 | 1.72915 | 54.64 | 0.54488 | |
| 5 | 215.9538 | DD[5] | | | | |
| *6 | 299.9678 | 2.0700 | 1.80780 | 40.86 | 0.56955 | |
| *7 | 14.1521 | 7.4600 | | | | |
| 8 | −22.6727 | 0.7000 | 1.51741 | 52.16 | 0.56212 | |
| 9 | 22.6727 | 4.7400 | 1.85027 | 32.27 | 0.59119 | |
| 10 | −35.9984 | 1.3500 | | | | |
| 11 | −18.4455 | 0.6000 | 1.49700 | 81.61 | 0.53887 | 20.6 |
| 12 | −55.5751 | DD[12] | | | | |
| 13 (St) | ∞ | 1.6000 | | | | |
| *14 | 25.5779 | 5.1300 | 1.68863 | 31.20 | 0.60109 | |
| *15 | −75.2777 | 3.2400 | | | | |
| 16 | 26.9753 | 0.6500 | 1.85451 | 25.15 | 0.61031 | |
| 17 | 14.5564 | 3.2400 | 1.43700 | 95.12 | 0.53487 | |
| 18 | 30.9451 | 1.4900 | | | | |
| 19 | ∞ | 0.5800 | 1.85451 | 25.15 | 0.61031 | |
| 20 | 21.9744 | 3.5400 | 1.49700 | 81.61 | 0.53887 | |
| 21 | −124.8640 | 1.1700 | | | | |
| *22 | 26.1996 | 5.4600 | 1.61884 | 63.56 | 0.54321 | |
| *23 | −22.8932 | DD[23] | | | | |
| 24 | 232.2641 | 2.1500 | 1.98613 | 16.48 | 0.66558 | |
| 25 | −88.4694 | 0.5800 | 1.83400 | 37.21 | 0.57834 | 21.6 |
| 26 | 23.2050 | DD[26] | | | | |
| *27 | −209.7857 | 3.0400 | 1.51625 | 64.05 | 0.53616 | |
| *28 | −41.0722 | 17.9243 | | | | |

TABLE 2
Example 1

| | Wide | Middle | Tele |
|---|---|---|---|
| Zr | 1.0 | 2.1 | 3.2 |
| f | 16.50 | 33.99 | 53.40 |
| Bf | 17.92 | 17.92 | 17.92 |
| FNo. | 2.88 | 2.88 | 2.89 |
| 2ω[°] | 88.6 | 44.8 | 29.4 |
| DD[5] | 0.80 | 19.17 | 30.67 |
| DD[12] | 20.91 | 5.28 | 1.00 |
| DD[23] | 1.71 | 4.15 | 3.31 |
| DD[26] | 7.33 | 13.09 | 22.84 |

TABLE 3
Example 1

| Sn | 6 | 7 | 14 | 15 |
|---|---|---|---|---|
| KA | 1.0000000E+00 | 1.0000000E+00 | 1.0000000E+00 | 1.0000000E+00 |
| A3 | 5.1399214E−20 | 0.0000000E+00 | 0.0000000E+00 | 0.0000000E+00 |
| A4 | 8.7888705E−05 | 6.8201279E−05 | −1.7335685E−05 | 1.3172312E−06 |
| A5 | −1.3286353E−05 | −1.0366188E−05 | 1.3343552E−07 | −2.9537953E−07 |
| A6 | 6.0289925E−07 | 4.0638564E−07 | −1.7021591E−07 | −1.5938297E−07 |
| A7 | 2.7073312E−08 | −2.9880690E−08 | 3.8204682E−08 | 5.4912513E−08 |
| A8 | −2.9096192E−09 | 1.2012628E−09 | −1.8848795E−09 | −2.9607266E−09 |
| A9 | 4.2965243E−11 | 5.3297058E−10 | −2.6347916E−10 | −3.5870465E−10 |
| A10 | 1.1763021E−12 | −3.8680743E−11 | 2.6924582E−11 | 3.6502996E−11 |
| Sn | 22 | 23 | 27 | 28 |
| KA | 1.0000000E+00 | 1.0000000E+00 | 1.0000000E+00 | 1.0000000E+00 |
| A3 | 5.6194476E−20 | 0.0000000E+00 | 0.0000000E+00 | 0.0000000E+00 |
| A4 | −2.4697797E−05 | 6.9473258E−06 | 1.3645834E−06 | 2.7872114E−05 |
| A5 | −2.5992613E−06 | −4.3389615E−07 | 2.2386580E−06 | −1.7781958E−06 |
| A6 | 4.4046609E−07 | −3.2538041E−08 | −3.1204780E−07 | 1.0818354E−08 |
| A7 | −2.1793454E−08 | 9.9687342E−09 | 1.3901254E−08 | 1.1087568E−08 |
| A8 | −2.0597814E−09 | −1.1385887E−09 | 1.9576814E−09 | 5.5540452E−10 |
| A9 | 1.6895704E−10 | −6.5035665E−11 | −1.1400117E−10 | −1.3796432E−11 |
| A10 | 1.2906854E−12 | 8.7949954E−12 | −3.3529432E−12 | −5.4619350E−12 |

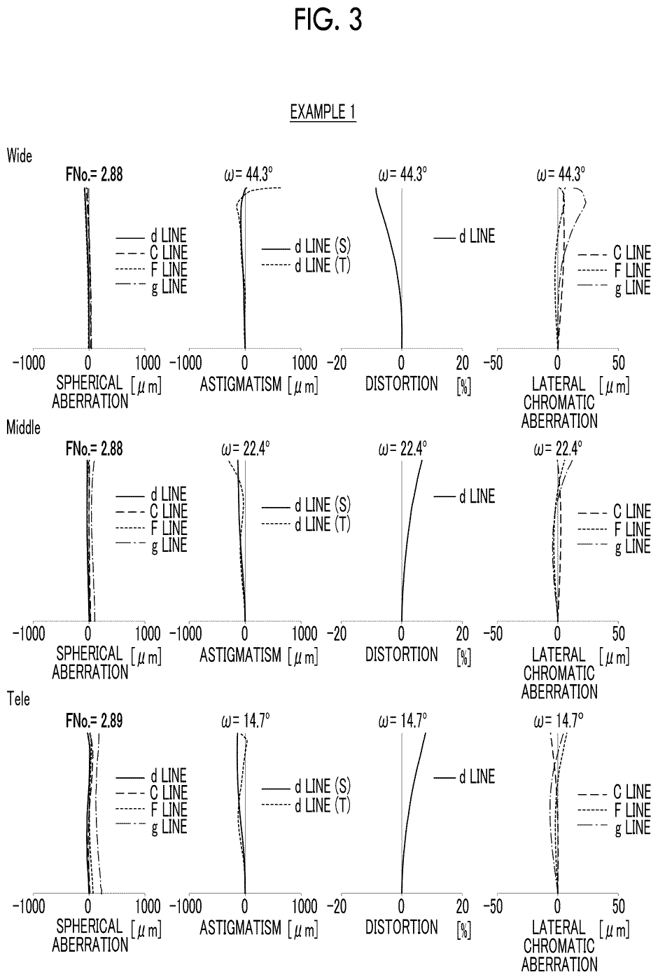

Each aberration diagram of the zoom lens of Example 1 is illustrated in FIG. 3. In FIG. 3, the spherical aberration, an astigmatism, a distortion, and the lateral chromatic aberration are illustrated in this order from the left. In FIG. 3, the aberrations in the wide angle end state are illustrated in an upper part labeled “Wide”, the aberrations in the middle focal length state are illustrated in a middle part labeled “Middle”, and the aberrations in the telephoto end state are illustrated in a lower part labeled “Tele”. In the spherical aberration diagram, aberrations on the d line, the C line, the F line, and the g line are illustrated by a solid line, a long broken line, a short broken line, and a dot-dashed line, respectively. In the astigmatism diagram, an aberration on the d line in a sagittal direction is illustrated by a solid line, and an aberration on the d line in a tangential direction is illustrated by a short broken line. In the distortion diagram, an aberration on the d line is illustrated by a solid line. In the lateral chromatic aberration diagram, aberrations on the C line, the F line, and the g line are illustrated by a long broken line, a short broken line, and a dot-dashed line, respectively. In the spherical aberration diagram, a value of the open F-number is shown after “FNo.=”. In other aberration diagrams, a value of the maximum half angle of view is shown after ω=.

Symbols, meanings, description methods, and illustration methods of each data related to Example 1 are basically the same for the following examples unless otherwise specified. Thus, duplicate descriptions will be omitted below.

### Example 2

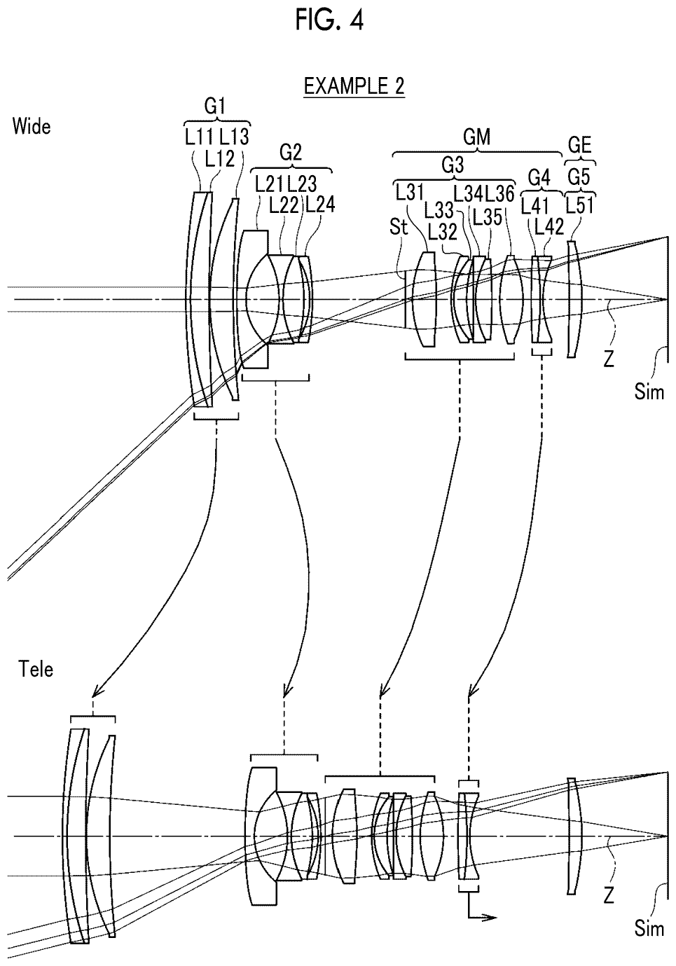

A configuration and a moving path of a zoom lens of Example 2 are illustrated in FIG. 4. The zoom lens of Example 2 consists of, in order from the object side to the image side, the first lens group G1 having a positive refractive power, the second lens group G2 having a negative refractive power, the third lens group G3 having a positive refractive power, the fourth lens group G4 having a negative refractive power, and the fifth lens group G5 having a positive refractive power. The intermediate group GM consists of the third lens group G3 and the fourth lens group G4. The final lens group GE consists of the fifth lens group G5. During the zooming from the wide angle end to the telephoto end, the first lens group G1, the second lens group G2, the third lens group G3, and the fourth lens group G4 move along the optical axis Z by changing spacings between adjacent lens groups, and the fifth lens group G5 is fixed with respect to the image plane Sim. The focus group consists of the fourth lens group G4. During the focusing from the infinite distance object to the nearest object, the focus group moves to the image side.

The first lens group G1 consists of three lenses including the lenses L11 to L13 in order from the object side to the image side. The second lens group G2 consists of four lenses including the lenses L21 to L24 in order from the object side to the image side. The third lens group G3 consists of the aperture stop St and six lenses including the lenses L31 to L36 in order from the object side to the image side. The fourth lens group G4 consists of two lenses including the lenses L41 and L42 in order from the object side to the image side. The fifth lens group G5 consists of one lens that is the lens L51.

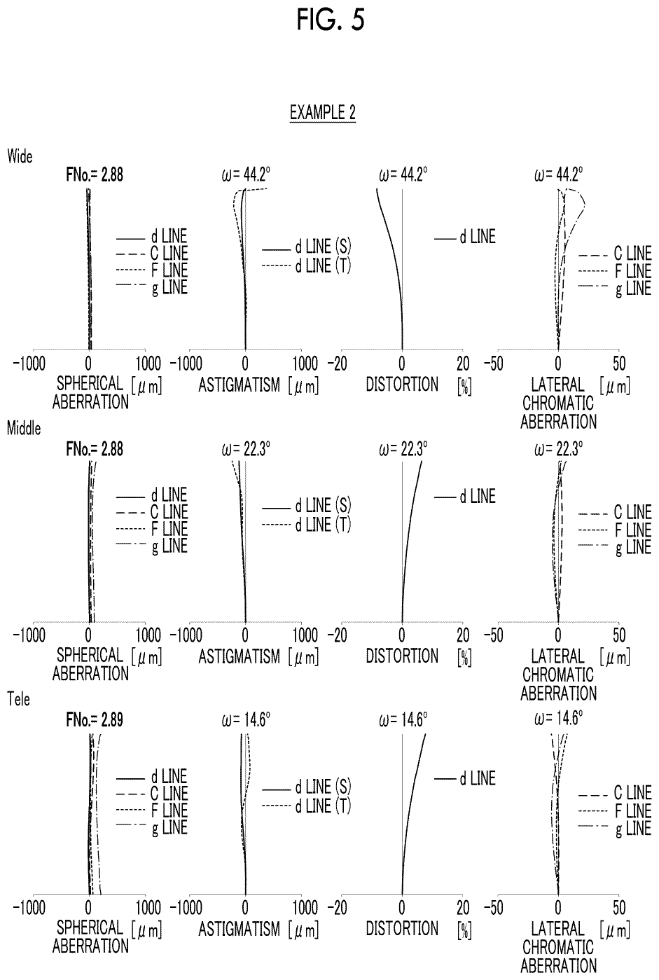

For the zoom lens of Example 2, Table 4 shows basic lens data, Table 5 shows specifications and a variable surface spacing, Table 6 shows aspherical coefficients, and FIG. 5 illustrates each aberration diagram.

TABLE 4
Example 2

| Sn | R | D | Nd | νd | θgF | DA |
|---|---|---|---|---|---|---|
| 1 | 164.4385 | 1.0480 | 1.84666 | 23.84 | 0.62012 | 52.4 |
| 2 | 81.9759 | 4.1935 | 1.49700 | 81.61 | 0.53887 | |
| 3 | 439.9879 | 0.1501 | | | | |
| 4 | 53.1321 | 5.2724 | 1.72916 | 54.67 | 0.54534 | |
| 5 | 229.6383 | DD[5] | | | | |
| *6 | 324.3955 | 2.0659 | 1.81000 | 40.99 | 0.56996 | |
| *7 | 14.5084 | 7.4567 | | | | |
| 8 | −22.2951 | 0.8670 | 1.51742 | 52.15 | 0.55911 | |
| 9 | 22.3925 | 4.7116 | 1.85026 | 32.22 | 0.59378 | |
| 10 | −37.5353 | 1.3241 | | | | |
| 11 | −18.4747 | 0.5916 | 1.49700 | 81.61 | 0.53887 | 20.6 |
| 12 | −53.7216 | DD[12] | | | | |
| 13 (St) | ∞ | 1.5998 | | | | |
| *14 | 25.1185 | 5.3979 | 1.68948 | 31.02 | 0.59874 | |
| *15 | −82.1250 | 3.3195 | | | | |
| 16 | 26.0094 | 0.5800 | 1.85451 | 25.15 | 0.61031 | |
| 17 | 14.3758 | 2.9093 | 1.43700 | 95.10 | 0.53364 | |
| 18 | 30.0138 | 1.4455 | | | | |
| 19 | ∞ | 0.5800 | 1.85451 | 25.15 | 0.61031 | |
| 20 | 21.3654 | 3.6478 | 1.49700 | 81.61 | 0.53887 | |
| 21 | −132.0720 | 1.7695 | | | | |
| *22 | 26.2347 | 5.2313 | 1.62087 | 63.83 | 0.54330 | |
| *23 | −22.6762 | DD[23] | | | | |
| 24 | 235.2546 | 1.9998 | 1.98613 | 16.48 | 0.66558 | |
| 25 | −84.0349 | 0.6396 | 1.83400 | 37.16 | 0.57759 | 21.6 |
| 26 | 23.0434 | DD[26] | | | | |
| *27 | −219.1215 | 2.8852 | 1.51633 | 64.06 | 0.53345 | |
| *28 | −42.3207 | 19.3712 | | | | |

TABLE 5
Example 2

| | Wide | Middle | Tele |
|---|---|---|---|
| Zr | 1.0 | 2.1 | 3.2 |
| f | 16.50 | 33.99 | 53.41 |
| Bf | 19.37 | 19.37 | 19.37 |
| FNo. | 2.88 | 2.88 | 2.89 |
| 2ω[°] | 88.4 | 44.6 | 29.2 |
| DD[5] | 0.80 | 18.75 | 30.46 |
| DD[12] | 20.78 | 4.91 | 1.00 |
| DD[23] | 1.86 | 4.37 | 3.29 |
| DD[26] | 5.89 | 11.87 | 22.36 |

TABLE 6
Example 2

| Sn | 6 | 7 | 14 | 15 |
|---|---|---|---|---|
| KA | 1.0000000E+00 | 1.0000000E+00 | 1.0000000E+00 | 1.0000000E+00 |
| A3 | −7.7098821E−20 | −3.2583086E−20 | 1.8731492E−20 | 1.8731492E−20 |
| A4 | 1.1354661E−04 | 1.0740789E−04 | −1.6434673E−05 | 4.2550052E−06 |
| A5 | −1.5303635E−05 | −1.4577308E−05 | 1.2705789E−06 | 6.6610812E−07 |
| A6 | 5.1637213E−07 | 4.3522384E−07 | −2.5095418E−07 | −1.5998558E−07 |
| A7 | 4.0273119E−08 | 1.3709361E−08 | 2.4212002E−08 | 2.9111764E−08 |
| A8 | −3.0406718E−09 | −2.1032353E−09 | 1.4819081E−10 | −7.8961587E−10 |
| A9 | 1.6234207E−11 | 4.1233946E−10 | −1.9562020E−10 | −1.9171483E−10 |
| A10 | 2.0441422E−12 | −2.3636615E−11 | 1.4103559E−11 | 1.7700374E−11 |
| Sn | 22 | 23 | 27 | 28 |
| KA | 1.0000000E+00 | 1.0000000E+00 | 1.0000000E+00 | 1.0000000E+00 |
| A3 | −3.7462984E−20 | 2.3414365E−21 | −3.5253233E−20 | 1.7626617E−20 |
| A4 | −2.4663582E−05 | 5.9068466E−06 | 2.5061707E−06 | 2.9801781E−05 |
| A5 | −1.7443406E−06 | 6.2362189E−07 | 4.5097074E−06 | −7.7887623E−07 |
| A6 | 4.0919089E−07 | −7.1136341E−08 | −4.3627236E−07 | 5.6447385E−08 |
| A7 | −3.6121129E−08 | −5.2827907E−09 | −1.7382848E−09 | −5.8921126E−09 |
| A8 | −6.2409819E−10 | 3.0282042E−10 | 2.4030402E−09 | 2.3565899E−10 |
| A9 | 2.3701199E−10 | 1.1598168E−11 | −7.8845836E−11 | 4.1913041E−11 |
| A10 | −9.0456952E−12 | −1.1561616E−12 | −3.7872507E−12 | −5.3257256E−12 |

### Example 3

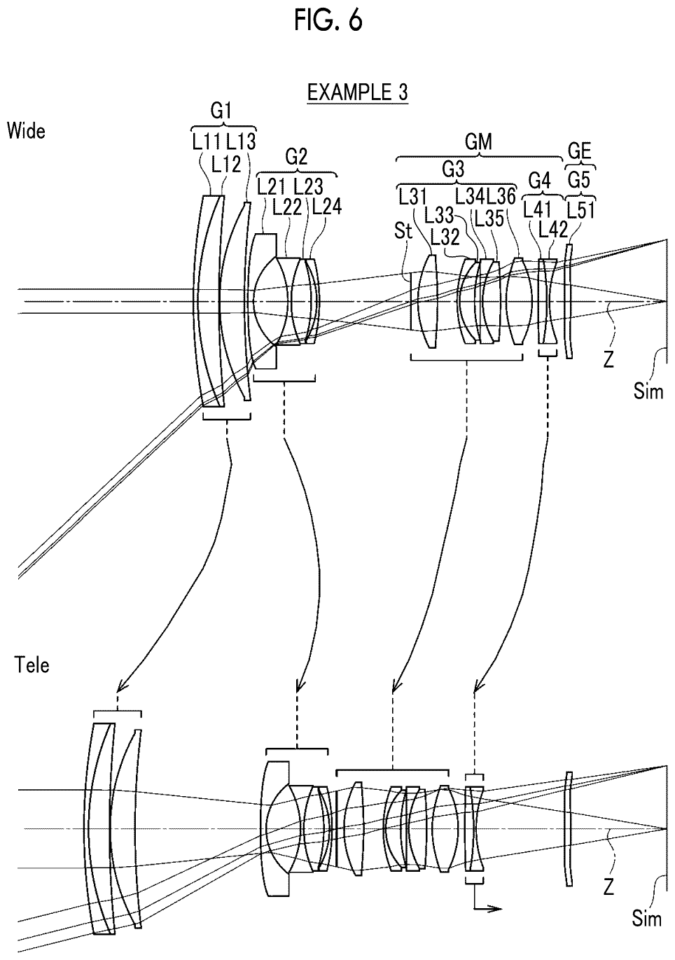

A configuration and a moving path of a zoom lens of Example 3 are illustrated in FIG. 6. The zoom lens of Example 3 consists of, in order from the object side to the image side, the first lens group G1 having a positive refractive power, the second lens group G2 having a negative refractive power, the third lens group G3 having a positive refractive power, the fourth lens group G4 having a negative refractive power, and the fifth lens group G5 having a positive refractive power. The intermediate group GM consists of the third lens group G3 and the fourth lens group G4. The final lens group GE consists of the fifth lens group G5. During the zooming from the wide angle end to the telephoto end, the first lens group G1, the second lens group G2, the third lens group G3, and the fourth lens group G4 move along the optical axis Z by changing spacings between adjacent lens groups, and the fifth lens group G5 is fixed with respect to the image plane Sim. The focus group consists of the fourth lens group G4. During the focusing from the infinite distance object to the nearest object, the focus group moves to the image side.

The first lens group G1 consists of three lenses including the lenses L11 to L13 in order from the object side to the image side. The second lens group G2 consists of four lenses including the lenses L21 to L24 in order from the object side to the image side. The third lens group G3 consists of the aperture stop St and six lenses including the lenses L31 to L36 in order from the object side to the image side. The fourth lens group G4 consists of two lenses including the lenses L41 and L42 in order from the object side to the image side. The fifth lens group G5 consists of one lens that is the lens L51.

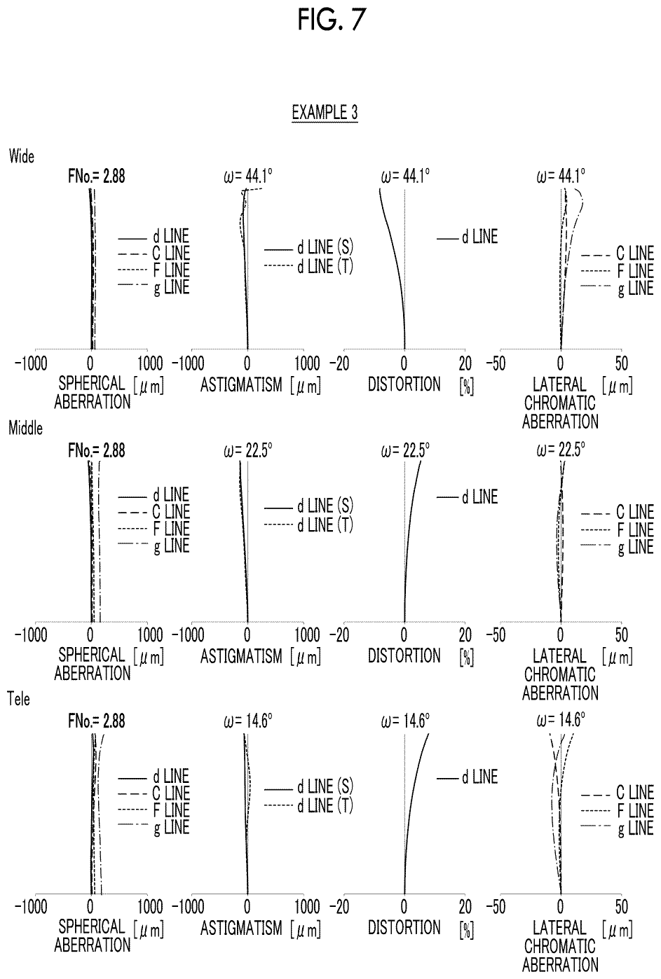

For the zoom lens of Example 3, Table 7 shows basic lens data, Table 8 shows specifications and a variable surface spacing, Table 9 shows aspherical coefficients, and FIG. 7 illustrates each aberration diagram.

TABLE 7
Example 3

| Sn | R | D | Nd | νd | θgF | DA |
|---|---|---|---|---|---|---|
| 1 | 137.8709 | 1.0480 | 1.84666 | 23.84 | 0.62012 | 52.4 |
| 2 | 64.4290 | 4.8088 | 1.49700 | 81.61 | 0.53887 | |
| 3 | 253.2999 | 0.1501 | | | | |
| 4 | 48.2756 | 5.6896 | 1.78800 | 47.37 | 0.55598 | |
| 5 | 196.1632 | DD[5] | | | | |
| *6 | 264.7795 | 1.2800 | 1.81000 | 40.99 | 0.56996 | |
| *7 | 13.8689 | 7.8730 | | | | |
| 8 | −21.3362 | 0.7632 | 1.51478 | 60.63 | 0.54252 | |
| 9 | 25.4220 | 4.5841 | 1.85026 | 32.22 | 0.59378 | |
| 10 | −33.3286 | 1.2814 | | | | |
| 11 | −18.9170 | 0.5916 | 1.61800 | 63.39 | 0.54015 | 20.6 |
| 12 | −42.3632 | DD[12] | | | | |
| 13 (St) | ∞ | 1.5998 | | | | |
| *14 | 22.9037 | 4.5039 | 1.68948 | 31.02 | 0.59874 | |
| *15 | −103.8258 | 4.4862 | | | | |
| 16 | 27.9844 | 0.5828 | 1.85451 | 25.15 | 0.61031 | |
| 17 | 13.4650 | 3.4115 | 1.43700 | 95.10 | 0.53364 | |
| 18 | 33.2174 | 1.2908 | | | | |
| 19 | 4970.6687 | 0.5800 | 1.85451 | 25.15 | 0.61031 | |
| 20 | 19.2961 | 4.0712 | 1.49700 | 81.61 | 0.53887 | |
| 21 | −119.9951 | 1.2887 | | | | |
| *22 | 24.0710 | 5.9489 | 1.62087 | 63.83 | 0.54330 | |
| *23 | −21.8232 | DD[23] | | | | |
| 24 | 296.0289 | 2.0002 | 1.98613 | 16.48 | 0.66558 | |
| 25 | −59.9010 | 0.5800 | 1.83400 | 37.16 | 0.57759 | 21.6 |
| 26 | 26.7717 | DD[26] | | | | |
| *27 | −311.6258 | 1.4318 | 1.51633 | 64.06 | 0.53345 | |
| *28 | −114.7398 | 22.0255 | | | | |

TABLE 8
Example 3

| | Wide | Middle | Tele |
|---|---|---|---|
| Zr | 1.0 | 2.1 | 3.2 |
| f | 16.50 | 33.99 | 53.40 |
| Bf | 22.03 | 22.03 | 22.03 |
| FNo. | 2.88 | 2.88 | 2.88 |
| 2ω[°] | 88.2 | 45.0 | 29.2 |
| DD[5] | 0.80 | 18.02 | 28.76 |
| DD[12] | 20.83 | 4.86 | 1.00 |
| DD[23] | 1.39 | 3.50 | 1.54 |
| DD[26] | 3.46 | 9.23 | 20.24 |

TABLE 9
Example 3

| Sn | 6 | 7 | 14 | 15 |
|---|---|---|---|---|
| KA | 1.0000000E+00 | 1.0000000E+00 | 1.0000000E+00 | 1.0000000E+00 |
| A3 | −5.7824116E−20 | −3.2583086E−20 | 1.8731492E−20 | 0.0000000E+00 |
| A4 | 1.0713786E−04 | 9.2945348E−05 | −1.9870873E−05 | −1.3739113E−06 |
| A5 | −1.5216344E−05 | −1.4787707E−05 | 5.6246669E−07 | 3.1530132E−08 |
| A6 | 5.7177106E−07 | 5.2308110E−07 | −1.9194113E−07 | −9.0419294E−08 |
| A7 | 4.1980102E−08 | 3.2410875E−08 | 3.1025977E−08 | 3.1209201E−08 |
| A8 | −3.3196649E−09 | −3.8097215E−09 | −8.0988367E−10 | −1.4393666E−09 |
| A9 | 8.9988723E−12 | 2.5727798E−10 | −2.3190113E−10 | −1.9982107E−10 |
| A10 | 2.7349252E−12 | −7.8630987E−12 | 1.7746879E−11 | 1.8141100E−11 |
| Sn | 22 | 23 | 27 | 28 |
| KA | 1.0000000E+00 | 1.0000000E+00 | 1.0000000E+00 | 1.0000000E+00 |
| A3 | 5.6194476E−20 | 0.0000000E+00 | 0.0000000E+00 | 3.5253233E−20 |
| A4 | −3.0522422E−05 | 5.2071018E−06 | 3.7954781E−05 | 5.5039366E−05 |
| A5 | −1.2098177E−06 | 7.8975660E−07 | −2.0976143E−06 | −4.9509682E−06 |
| A6 | 3.8157274E−07 | −5.0928166E−08 | −3.4320010E−07 | 6.9963164E−08 |
| A7 | −4.2376784E−08 | −1.2004224E−08 | 7.2552466E−08 | 4.7376074E−08 |
| A8 | 2.7086026E−11 | 6.6098913E−10 | 8.8316342E−11 | −5.4200127E−10 |
| A9 | 2.6016483E−10 | 5.5082683E−11 | −2.9314385E−10 | −1.0827860E−10 |
| A10 | −1.2248800E−11 | −4.6371033E−12 | 4.4035804E−12 | −2.7175984E−12 |

### Example 4

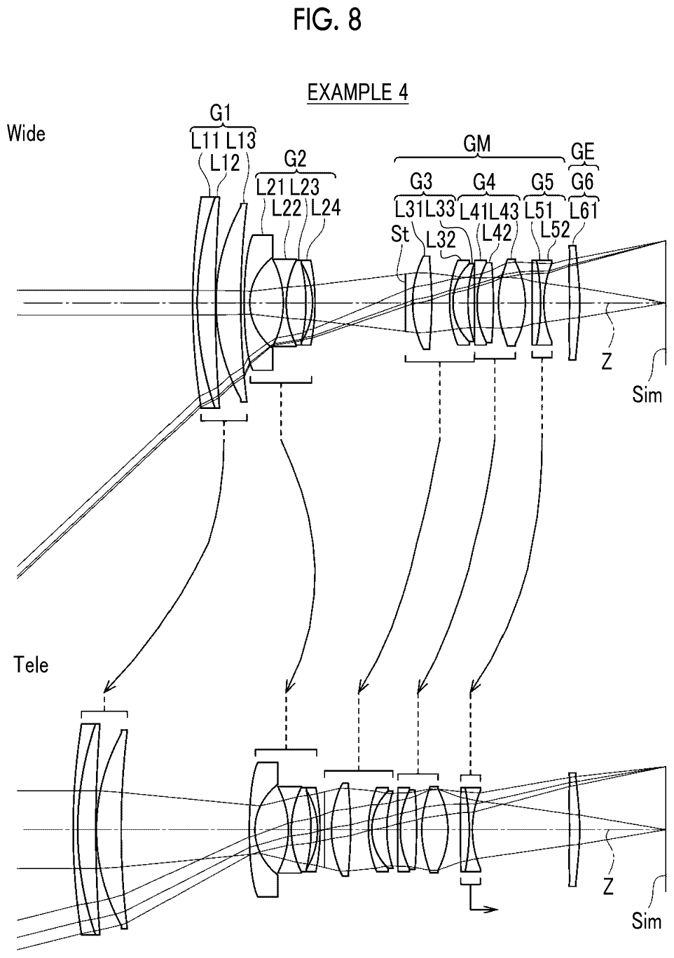

A configuration and a moving path of a zoom lens of Example 4 are illustrated in FIG. 8. The zoom lens of Example 4 consists of, in order from the object side to the image side, the first lens group G1 having a positive refractive power, the second lens group G2 having a negative refractive power, the third lens group G3 having a positive refractive power, the fourth lens group G4 having a positive refractive power, the fifth lens group G5 having a negative refractive power, and the sixth lens group G6 having a positive refractive power. The intermediate group GM consists of the third lens group G3, the fourth lens group G4, and the fifth lens group G5. The final lens group GE consists of the sixth lens group G6. During the zooming from the wide angle end to the telephoto end, the first lens group G1, the second lens group G2, the third lens group G3, the fourth lens group G4, and the fifth lens group G5 move along the optical axis Z by changing spacings between adjacent lens groups, and the sixth lens group G6 is fixed with respect to the image plane Sim. The focus group consists of the fifth lens group G5. During the focusing from the infinite distance object to the nearest object, the focus group moves to the image side.

The first lens group G1 consists of three lenses including the lenses L11 to L13 in order from the object side to the image side. The second lens group G2 consists of four lenses including the lenses L21 to L24 in order from the object side to the image side. The third lens group G3 consists of the aperture stop St and three lenses including the lenses L31 to L33 in order from the object side to the image side. The fourth lens group G4 consists of three lenses including lenses L41 to L43 in order from the object side to the image side. The fifth lens group G5 consists of two lenses including lenses L51 and L52 in order from the object side to the image side. The sixth lens group G6 consists of one lens that is a lens L61.

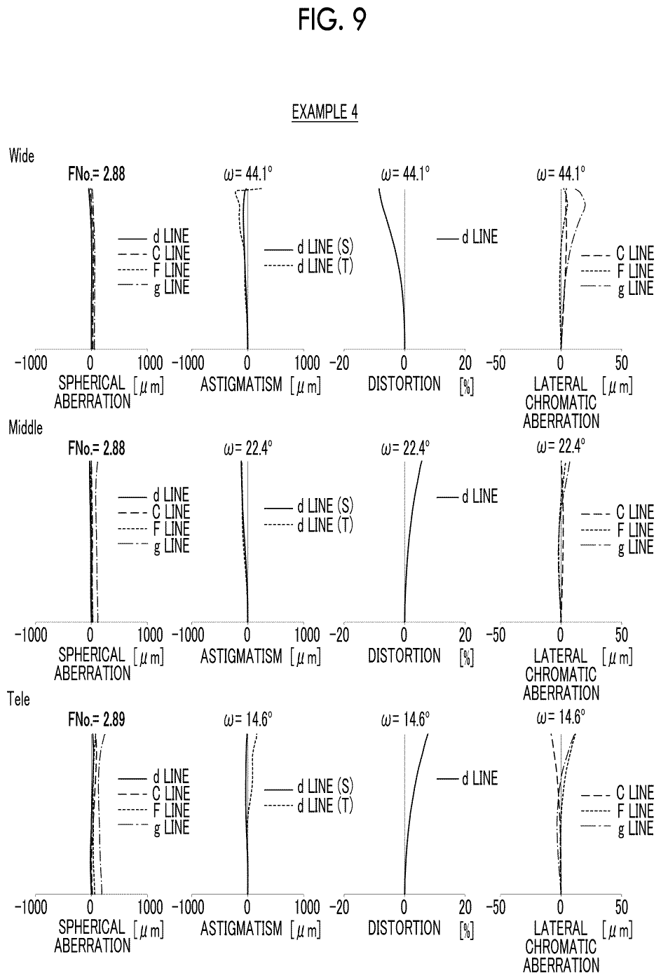

For the zoom lens of Example 4, Table 10 shows basic lens data, Table 11 shows specifications and a variable surface spacing, Table 12 shows aspherical coefficients, and FIG. 9 illustrates each aberration diagram.

TABLE 10
Example 4

| Sn | R | D | Nd | νd | θgF | DA |
|---|---|---|---|---|---|---|
| 1 | 162.0207 | 1.0480 | 1.84666 | 23.84 | 0.62012 | 52.4 |
| 2 | 78.5365 | 4.1467 | 1.49700 | 81.61 | 0.53887 | |
| 3 | 333.9662 | 0.1498 | | | | |
| 4 | 48.4548 | 5.6784 | 1.72916 | 54.67 | 0.54534 | |
| 5 | 198.0812 | DD[5] | | | | |
| *6 | 155.6900 | 1.2816 | 1.81000 | 40.99 | 0.56996 | |
| *7 | 13.6488 | 7.6584 | | | | |
| 8 | −22.9755 | 0.6960 | 1.51478 | 60.63 | 0.54252 | |
| 9 | 23.2390 | 4.5168 | 1.85026 | 32.22 | 0.59378 | |
| 10 | −40.4138 | 1.4859 | | | | |
| 11 | −18.4048 | 0.5916 | 1.49700 | 81.61 | 0.53887 | 20.6 |
| 12 | −50.5777 | DD[12] | | | | |
| 13 (St) | ∞ | 1.5998 | | | | |
| *14 | 24.0233 | 4.3858 | 1.68948 | 31.02 | 0.59874 | |
| *15 | −93.7955 | 4.0953 | | | | |
| 16 | 27.3638 | 0.7759 | 1.85451 | 25.15 | 0.61031 | |
| 17 | 13.1391 | 3.4394 | 1.43700 | 95.10 | 0.53364 | |
| 18 | 30.6240 | DD[18] | | | | |
| 19 | 778.1626 | 0.5800 | 1.85451 | 25.15 | 0.61031 | |
| 20 | 21.5736 | 3.7480 | 1.49700 | 81.61 | 0.53887 | |
| 21 | −120.0056 | 1.1907 | | | | |
| *22 | 23.9913 | 6.0111 | 1.62087 | 63.83 | 0.54330 | |
| *23 | −21.1961 | DD[23] | | | | |
| 24 | 701.3380 | 2.0002 | 1.98613 | 16.48 | 0.66558 | |
| 25 | −53.3083 | 0.7264 | 1.83400 | 37.16 | 0.57759 | 21.6 |
| 26 | 24.1771 | DD[26] | | | | |
| *27 | −368.4492 | 2.3522 | 1.51633 | 64.06 | 0.53345 | |
| *28 | −60.6568 | 19.7571 | | | | |

TABLE 11
Example 4

| | Wide | Middle | Tele |
|---|---|---|---|
| Zr | 1.0 | 2.1 | 3.2 |
| f | 16.50 | 33.99 | 53.40 |
| Bf | 19.76 | 19.76 | 19.76 |
| FNo. | 2.88 | 2.88 | 2.89 |
| 2ω[°] | 88.2 | 44.8 | 29.2 |
| DD[5] | 0.80 | 18.38 | 29.27 |
| DD[12] | 20.77 | 4.72 | 1.00 |
| DD[18] | 1.50 | 2.13 | 2.50 |
| DD[23] | 1.53 | 4.22 | 2.88 |
| DD[26] | 5.87 | 11.02 | 22.13 |

TABLE 12
Example 4

| Sn | 6 | 7 | 14 | 15 |
|---|---|---|---|---|
| KA | 1.0000000E+00 | 1.0000000E+00 | 1.0000000E+00 | 1.0000000E+00 |
| A3 | 0.0000000E+00 | −1.9549851E−19 | 1.8731492E−20 | 1.8731492E−20 |
| A4 | 1.0679424E−04 | 9.4091104E−05 | −1.9084215E−05 | −8.9769205E−07 |
| A5 | −1.5765185E−05 | −1.6252033E−05 | −1.3063722E−07 | −5.2853819E−07 |
| A6 | 5.8046254E−07 | 6.7388023E−07 | −1.1252641E−07 | −5.4640457E−08 |
| A7 | 4.3700735E−08 | 2.8744103E−08 | 3.5498796E−08 | 4.2353863E−08 |
| A8 | −3.3514476E−09 | −5.3129386E−09 | −1.6603287E−09 | −2.3613903E−09 |
| A9 | 8.5403224E−12 | 3.4617943E−10 | −2.2549552E−10 | −2.4833105E−10 |
| A10 | 2.7308197E−12 | −8.4816104E−12 | 2.1224771E−11 | 2.4883079E−11 |

| Sn | 22 | 23 | 27 | 28 |
|---|---|---|---|---|
| KA | 1.0000000E+00 | 1.0000000E+00 | 1.0000000E+00 | 1.0000000E+00 |
| A3 | 7.4925968E−20 | −4.0975139E−21 | 0.0000000E+00 | −1.7626617E−20 |
| A4 | −2.9700558E−05 | 6.4189230E−06 | −4.6310624E−06 | 1.9924520E−05 |
| A5 | −2.0085819E−06 | 7.9795506E−07 | 4.0785274E−06 | −9.4017956E−07 |
| A6 | 4.5064202E−07 | −9.9211213E−08 | −3.8070289E−07 | 1.5815568E−07 |
| A7 | −3.7176856E−08 | −2.8693378E−09 | 4.4056233E−09 | −8.8003278E−09 |
| A8 | −6.7993655E−10 | 5.1055324E−10 | 2.2946731E−09 | 3.6256490E−10 |
| A9 | 2.5007726E−10 | −9.3505422E−12 | −9.7663358E−11 | 6.0004173E−11 |
| A10 | −9.9586952E−12 | −8.6345930E−13 | −3.4280408E−12 | −6.7854403E−12 |

### Example 5

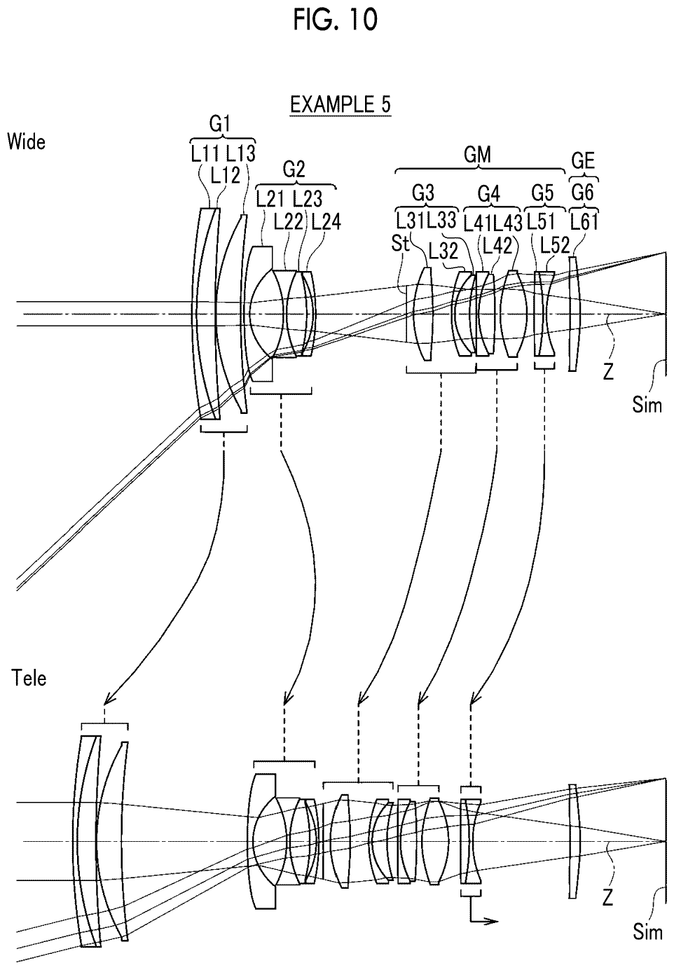

A configuration and a moving path of a zoom lens of Example 5 are illustrated in FIG. 10. The zoom lens of Example 5 consists of, in order from the object side to the image side, the first lens group G1 having a positive refractive power, the second lens group G2 having a negative refractive power, the third lens group G3 having a positive refractive power, the fourth lens group G4 having a positive refractive power, the fifth lens group G5 having a negative refractive power, and the sixth lens group G6 having a positive refractive power. The intermediate group GM consists of the third lens group G3, the fourth lens group G4, and the fifth lens group G5. The final lens group GE consists of the sixth lens group G6. During the zooming from the wide angle end to the telephoto end, the first lens group G1, the second lens group G2, the third lens group G3, the fourth lens group G4, and the fifth lens group G5 move along the optical axis Z by changing spacings between adjacent lens groups, and the sixth lens group G6 is fixed with respect to the image plane Sim. The focus group consists of the fifth lens group G5. During the focusing from the infinite distance object to the nearest object, the focus group moves to the image side.

The first lens group G1 consists of three lenses including the lenses L11 to L13 in order from the object side to the image side. The second lens group G2 consists of four lenses including the lenses L21 to L24 in order from the object side to the image side. The third lens group G3 consists of the aperture stop St and three lenses including the lenses L31 to L33 in order from the object side to the image side. The fourth lens group G4 consists of three lenses including the lenses L41 to L43 in order from the object side to the image side. The fifth lens group G5 consists of two lenses including the lenses L51 and L52 in order from the object side to the image side. The sixth lens group G6 consists of one lens that is the lens L61.

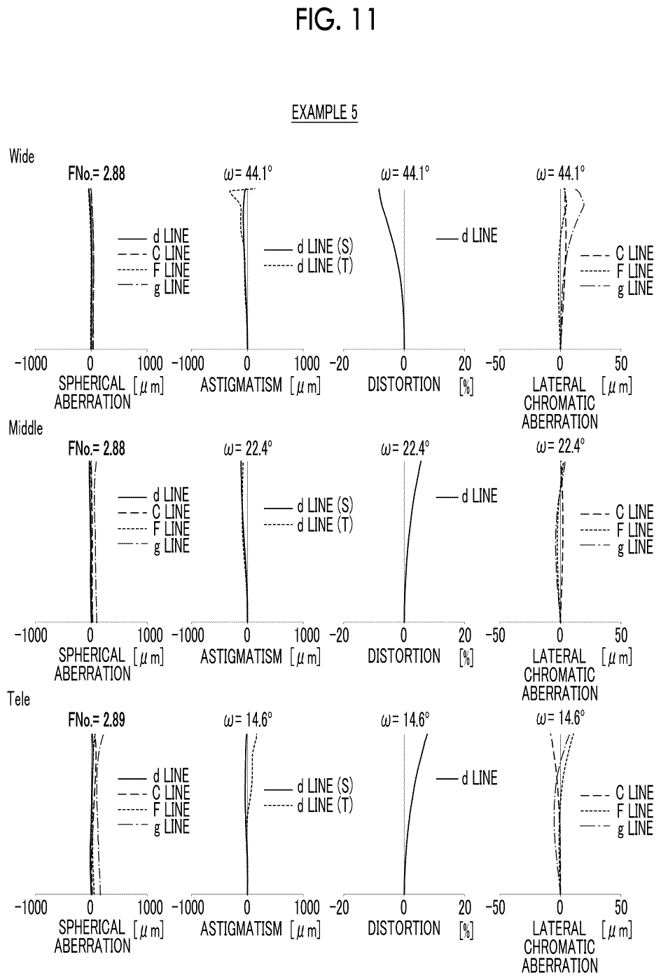

For the zoom lens of Example 5, Table 13 shows basic lens data, Table 14 shows specifications and a variable surface spacing, Table 15 shows aspherical coefficients, and FIG. 11 illustrates each aberration diagram.

TABLE 13
Example 5

| Sn | R | D | Nd | νd | θgF | DA |
|---|---|---|---|---|---|---|
| 1 | 153.4581 | 1.0480 | 1.84666 | 23.84 | 0.62012 | 52.4 |
| 2 | 73.4176 | 4.2674 | 1.49700 | 81.61 | 0.53887 | |
| 3 | 279.9559 | 0.1498 | | | | |
| 4 | 47.8873 | 5.6876 | 1.75500 | 52.32 | 0.54757 | |
| 5 | 188.3011 | DD[5] | | | | |
| *6 | 154.3565 | 1.2800 | 1.81000 | 40.99 | 0.56996 | |
| *7 | 13.7170 | 7.7342 | | | | |
| 8 | −22.6912 | 0.6960 | 1.51478 | 60.63 | 0.54252 | |
| 9 | 23.5609 | 4.6083 | 1.85026 | 32.22 | 0.59378 | |
| 10 | −38.8608 | 1.4686 | | | | |
| 11 | −18.7007 | 0.5916 | 1.55032 | 75.50 | 0.54001 | 20.6 |
| 12 | −46.7403 | DD[12] | | | | |
| 13 (St) | ∞ | 1.6002 | | | | |
| *14 | 24.0210 | 4.4426 | 1.68948 | 31.02 | 0.59874 | |
| *15 | −91.9845 | 4.2432 | | | | |
| 16 | 28.0839 | 0.7687 | 1.85451 | 25.15 | 0.61031 | |
| 17 | 13.1553 | 3.4059 | 1.43700 | 95.10 | 0.53364 | |
| 18 | 31.1217 | DD[18] | | | | |
| 19 | 1369.9145 | 0.5800 | 1.80518 | 25.42 | 0.61616 | |
| 20 | 20.9710 | 3.7007 | 1.48071 | 85.29 | 0.53623 | |
| 21 | −126.1919 | 1.2163 | | | | |
| *22 | 24.0076 | 6.1225 | 1.62087 | 63.83 | 0.54330 | |
| *23 | −21.1447 | DD[23] | | | | |
| 24 | 717.1351 | 2.0002 | 1.98613 | 16.48 | 0.66558 | |
| 25 | −52.9796 | 0.7794 | 1.83400 | 37.16 | 0.57759 | 21.6 |
| 26 | 24.2037 | DD[26] | | | | |
| *27 | −287.5255 | 2.3493 | 1.51633 | 64.06 | 0.53345 | |
| *28 | −58.0787 | 19.6152 | | | | |

TABLE 14
Example 5

| | Wide | Middle | Tele |
|---|---|---|---|
| Zr | 1.0 | 2.1 | 3.2 |
| f | 16.50 | 33.99 | 53.40 |
| Bf | 19.62 | 19.62 | 19.62 |
| FNo. | 2.88 | 2.88 | 2.89 |
| 2ω[°] | 88.2 | 44.8 | 29.2 |
| DD[5] | 0.80 | 18.20 | 28.84 |
| DD[12] | 20.67 | 4.56 | 1.00 |
| DD[18] | 1.50 | 2.13 | 2.50 |
| DD[23] | 1.68 | 4.30 | 2.74 |
| DD[26] | 5.38 | 10.60 | 22.26 |

TABLE 15
Example 5

| Sn | 6 | 7 | 14 | 15 |
|---|---|---|---|---|
| KA | 1.0000000E+00 | 1.0000000E+00 | 1.0000000E+00 | 1.0000000E+00 |
| A3 | 0.0000000E+00 | −1.9549851E−19 | 1.8731492E−20 | 1.8731492E−20 |
| A4 | 1.0679424E−04 | 9.4091104E−05 | −1.9084215E−05 | −8.9769205E−07 |
| A5 | −1.5765185E−05 | −1.6252033E−05 | −1.3063722E−07 | −5.2853819E−07 |
| A6 | 5.8046254E−07 | 6.7388023E−07 | −1.1252641E−07 | −5.4640457E−08 |
| A7 | 4.3700735E−08 | 2.8744103E−08 | 3.5498796E−08 | 4.2353863E−08 |
| A8 | −3.3514476E−09 | −5.3129386E−09 | −1.6603287E−09 | −2.3613903E−09 |
| A9 | 8.5403224E−12 | 3.4617943E−10 | −2.2549552E−10 | −2.4833105E−10 |
| A10 | 2.7308197E−12 | −8.4816104E−12 | 2.1224771E−11 | 2.4883079E−11 |

| Sn | 22 | 23 | 27 | 28 |
|---|---|---|---|---|
| KA | 1.0000000E+00 | 1.0000000E+00 | 1.0000000E+00 | 1.0000000E+00 |
| A3 | 7.4925968E−20 | −4.0975139E−21 | 0.0000000E+00 | −1.7626617E−20 |
| A4 | −2.9700558E−05 | 6.4189230E−06 | −4.6310624E−06 | 1.9924520E−05 |
| AS | −2.0085819E−06 | 7.9795506E−07 | 4.0785274E−06 | −9.4017956E−07 |
| A6 | 4.5064202E−07 | −9.9211213E−08 | −3.8070289E−07 | 1.5815568E−07 |
| A7 | −3.7176856E−08 | −2.8693378E−09 | 4.4056233E−09 | −8.8003278E−09 |
| A8 | −6.7993655E−10 | 5.1055324E−10 | 2.2946731E−09 | 3.6256490E−10 |
| A9 | 2.5007726E−10 | −9.3505422E−12 | −9.7663358E−11 | 6.0004173E−11 |
| A10 | −9.9586952E−12 | −8.6345930E−13 | −3.4280408E−12 | −6.7854403E−12 |

### Example 6

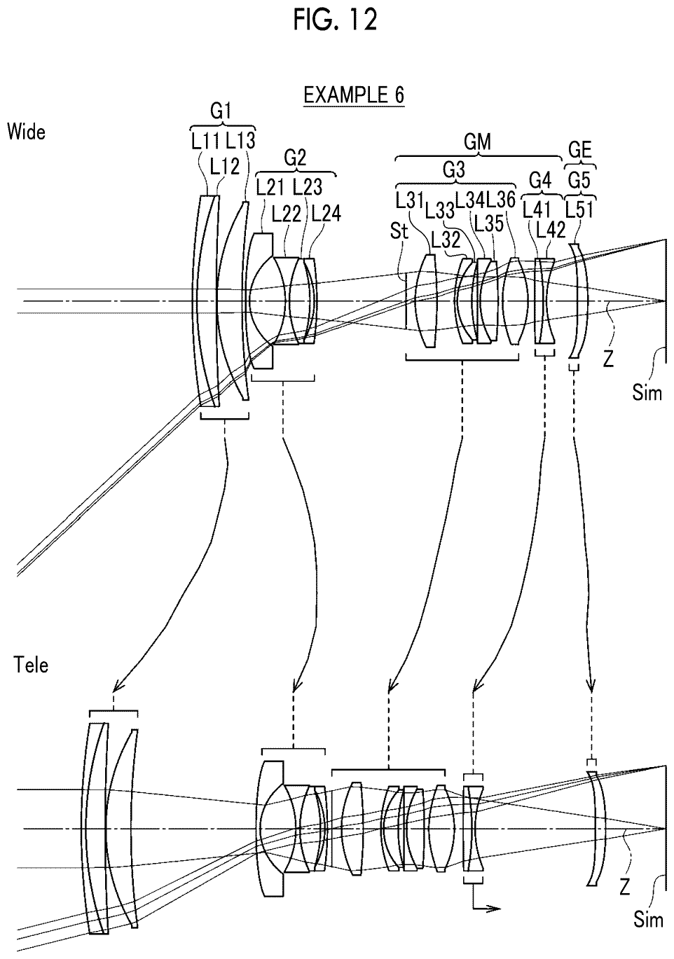

A configuration and a moving path of a zoom lens of Example 6 are illustrated in FIG. 12. The zoom lens of Example 6 consists of, in order from the object side to the image side, the first lens group G1 having a positive refractive power, the second lens group G2 having a negative refractive power, the third lens group G3 having a positive refractive power, the fourth lens group G4 having a negative refractive power, and the fifth lens group G5 having a positive refractive power. The intermediate group GM consists of the third lens group G3 and the fourth lens group G4. The final lens group GE consists of the fifth lens group G5. During the zooming from the wide angle end to the telephoto end, all lens groups move along the optical axis Z by changing spacings between adjacent lens groups. The focus group consists of the fourth lens group G4. During the focusing from the infinite distance object to the nearest object, the focus group moves to the image side.

The first lens group G1 consists of three lenses including the lenses L11 to L13 in order from the object side to the image side. The second lens group G2 consists of four lenses including the lenses L21 to L24 in order from the object side to the image side. The third lens group G3 consists of the aperture stop St and six lenses including the lenses L31 to L36 in order from the object side to the image side. The fourth lens group G4 consists of two lenses including the lenses L41 and L42 in order from the object side to the image side. The fifth lens group G5 consists of one lens that is the lens L51.

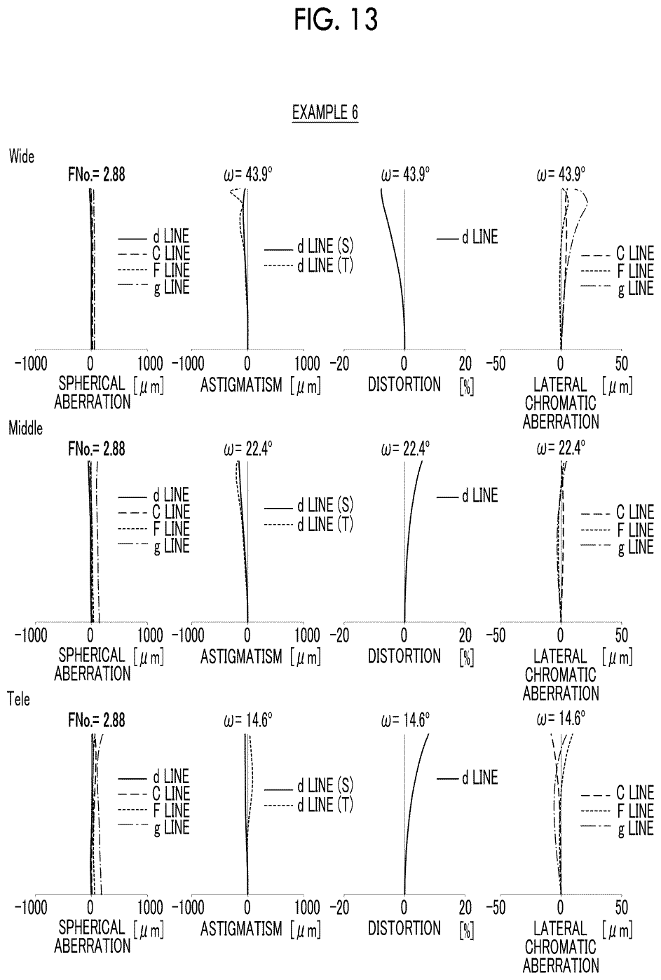

For the zoom lens of Example 6, Table 16 shows basic lens data, Table 17 shows specifications and a variable surface spacing, Table 18 shows aspherical coefficients, and FIG. 13 illustrates each aberration diagram.

TABLE 16
Example 6

| Sn | R | D | Nd | νd | θgF | DA |
|---|---|---|---|---|---|---|
| 1 | 161.5156 | 1.0480 | 1.84666 | 23.84 | 0.62012 | 52.4 |
| 2 | 77.7002 | 4.4204 | 1.49700 | 81.61 | 0.53887 | |
| 3 | 440.0697 | 0.1501 | | | | |
| 4 | 46.9766 | 5.7554 | 1.72916 | 54.67 | 0.54534 | |
| 5 | 179.6470 | DD[5] | | | | |
| *6 | 145.9222 | 0.9280 | 1.81000 | 40.99 | 0.56996 | |
| *7 | 13.4712 | 8.1987 | | | | |
| 8 | −21.2666 | 0.9212 | 1.51742 | 52.15 | 0.55911 | |
| 9 | 24.7974 | 4.7155 | 1.85026 | 32.22 | 0.59378 | |
| 10 | −31.8609 | 0.9931 | | | | |
| 11 | −19.2853 | 0.5916 | 1.49700 | 81.61 | 0.53887 | 20.6 |
| 12 | −75.6121 | DD[12] | | | | |
| 13 (St) | ∞ | 2.0951 | | | | |
| *14 | 23.2709 | 4.9779 | 1.68948 | 31.02 | 0.59874 | |
| *15 | −98.5802 | 4.0481 | | | | |
| 16 | 27.9441 | 0.6255 | 1.85451 | 25.15 | 0.61031 | |
| 17 | 13.8827 | 3.3280 | 1.43700 | 95.10 | 0.53364 | |
| 18 | 33.8974 | 1.3254 | | | | |
| 19 | −966.3593 | 0.5800 | 1.85451 | 25.15 | 0.61031 | |
| 20 | 19.3879 | 4.0820 | 1.49700 | 81.61 | 0.53887 | |
| 21 | −123.1264 | 1.0341 | | | | |
| *22 | 23.9326 | 5.8406 | 1.62087 | 63.83 | 0.54330 | |
| *23 | −21.9064 | DD[23] | | | | |
| 24 | 354.6283 | 2.0002 | 1.98613 | 16.48 | 0.66558 | |
| 25 | −57.5962 | 0.7437 | 1.83400 | 37.16 | 0.57759 | 21.6 |
| 26 | 24.9379 | DD[26] | | | | |
| *27 | −846.6112 | 2.3992 | 1.51633 | 64.06 | 0.53345 | |
| *28 | −70.6592 | DD[28] | | | | |

TABLE 17
Example 6

| | Wide | Middle | Tele |
|---|---|---|---|
| Zr | 1.0 | 2.1 | 3.2 |
| f | 16.49 | 33.99 | 53.40 |
| Bf | 17.93 | 14.49 | 13.83 |
| FNo. | 2.88 | 2.88 | 2.88 |
| 2ω[°] | 87.8 | 44.8 | 29.2 |
| DD[5] | 0.80 | 18.06 | 28.66 |
| DD[12] | 20.30 | 4.74 | 1.00 |
| DD[23] | 1.50 | 3.78 | 2.02 |
| DD[26] | 7.05 | 16.03 | 27.51 |
| DD[28] | 17.93 | 14.49 | 13.83 |

TABLE 18
Example 6

| Sn | 6 | 7 | 14 | 15 |
|---|---|---|---|---|
| KA | 1.0000000E+00 | 1.0000000E+00 | 1.0000000E+00 | 1.0000000E+00 |
| A3 | 5.1399214E−20 | 1.6291543E−19 | 1.8731492E−20 | 3.7462984E−20 |
| A4 | 8.5471787E−05 | 7.1760248E−05 | −1.8745069E−05 | −1.9421673E−06 |
| A5 | −1.3559618E−05 | −1.4349626E−05 | 4.8331153E−07 | 5.2647262E−07 |
| A6 | 6.4683833E−07 | 8.0852842E−07 | −1.5390491E−07 | −1.4885475E−07 |
| A7 | 3.0335736E−08 | 5.4596064E−09 | 2.4147024E−08 | 2.9812650E−08 |
| A8 | −3.2612783E−09 | −4.3169145E−09 | −6.0513858E−10 | −8.5213515E−10 |
| A9 | 3.4510392E−11 | 4.2666163E−10 | −1.8150955E−10 | −2.1285698E−10 |
| A10 | 2.1253340E−12 | −1.6840446E−11 | 1.3491572E−11 | 1.6125758E−11 |

| Sn | 22 | 23 | 27 | 28 |
|---|---|---|---|---|
| KA | 1.0000000E+00 | 1.0000000E+00 | 1.0000000E+00 | 1.0000000E+00 |
| A3 | −3.7462984E−20 | 2.3414365E−21 | 0.0000000E+00 | 1.0575970E−19 |
| A4 | −2.9106522E−05 | 7.1404299E−06 | −2.3920385E−05 | −3.5254389E−07 |
| A5 | −1.5849860E−06 | 8.1521619E−07 | −1.1755133E−06 | −6.0556808E−06 |
| A6 | 3.9939833E−07 | −9.1145043E−08 | −2.9679569E−07 | 2.6174884E−07 |
| A7 | −3.5494481E−08 | −3.9676245E−09 | 3.1624164E−08 | 1.4504093E−08 |
| A8 | −5.1185931E−10 | 4.3079131E−10 | 2.5203769E−10 | −1.4306483E−09 |
| A9 | 2.1484090E−10 | −4.7951965E−12 | −1.6485967E−10 | −2.1984067E−12 |
| A10 | −8.2412963E−12 | −8.3289761E−13 | 4.8102849E−12 | 9.5450287E−13 |

### Example 7

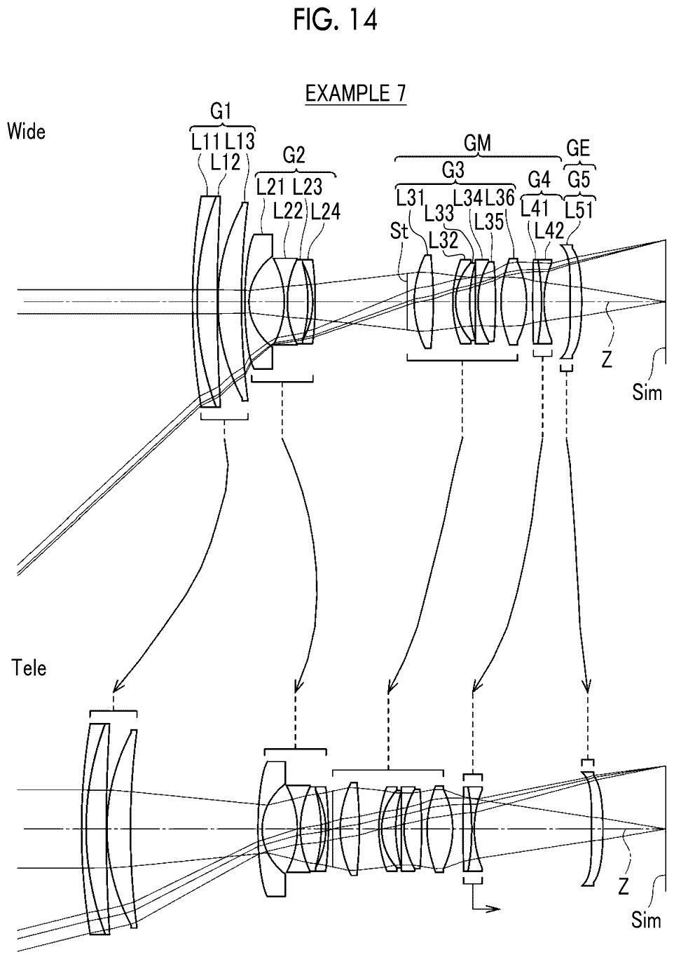

A configuration and a moving path of a zoom lens of Example 7 are illustrated in FIG. 14. The zoom lens of Example 7 consists of, in order from the object side to the image side, the first lens group G1 having a positive refractive power, the second lens group G2 having a negative refractive power, the third lens group G3 having a positive refractive power, the fourth lens group G4 having a negative refractive power, and the fifth lens group G5 having a positive refractive power. The intermediate group GM consists of the third lens group G3 and the fourth lens group G4. The final lens group GE consists of the fifth lens group G5. During the zooming from the wide angle end to the telephoto end, all lens groups move along the optical axis Z by changing spacings between adjacent lens groups. The focus group consists of the fourth lens group G4. During the focusing from the infinite distance object to the nearest object, the focus group moves to the image side.

The first lens group G1 consists of three lenses including the lenses L11 to L13 in order from the object side to the image side. The second lens group G2 consists of four lenses including the lenses L21 to L24 in order from the object side to the image side. The third lens group G3 consists of the aperture stop St and six lenses including the lenses L31 to L36 in order from the object side to the image side. The fourth lens group G4 consists of two lenses including the lenses L41 and L42 in order from the object side to the image side. The fifth lens group G5 consists of one lens that is the lens L51.

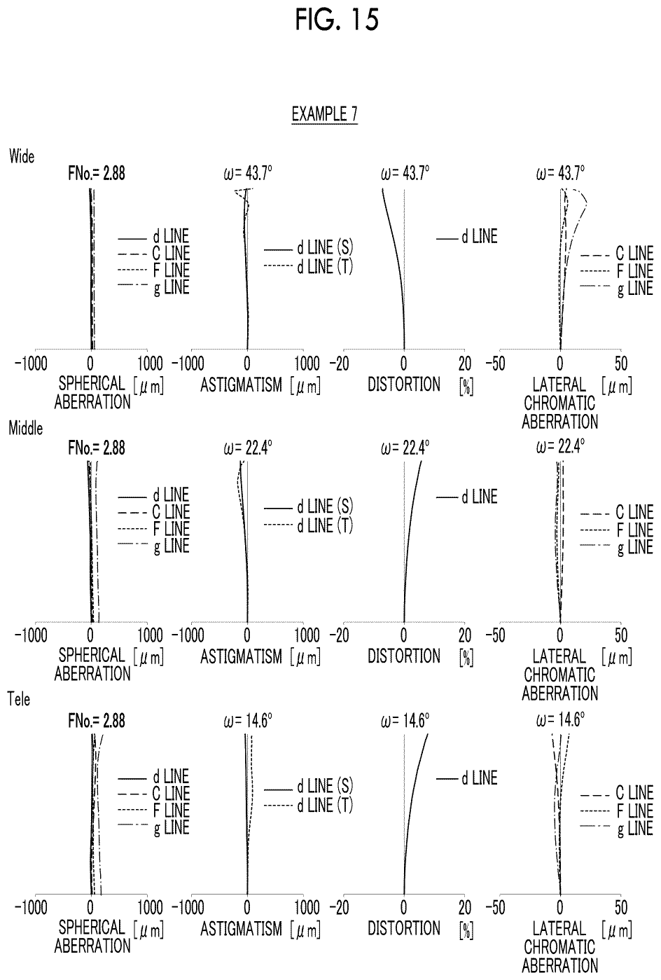

For the zoom lens of Example 7, Table 19 shows basic lens data, Table 20 shows specifications and a variable surface spacing, Table 21 shows aspherical coefficients, and FIG. 15 illustrates each aberration diagram.

TABLE 19
Example 7

| Sn | R | D | Nd | νd | θgF | DA |
|---|---|---|---|---|---|---|
| 1 | 157.2086 | 1.0480 | 1.84666 | 23.84 | 0.62012 | 52.4 |
| 2 | 73.4367 | 4.6260 | 1.49700 | 81.61 | 0.53887 | |
| 3 | 411.4281 | 0.1502 | | | | |
| 4 | 49.8628 | 5.3966 | 1.77250 | 49.60 | 0.55212 | |
| 5 | 186.2802 | DD[5] | | | | |
| *6 | 110.5358 | 0.9384 | 1.81000 | 40.99 | 0.56996 | |
| *7 | 13.2305 | 8.0816 | | | | |
| 8 | −22.4032 | 0.6960 | 1.51742 | 52.43 | 0.55649 | |
| 9 | 23.8371 | 4.7396 | 1.85026 | 32.22 | 0.59378 | |
| 10 | −34.0900 | 1.0734 | | | | |
| 11 | −19.4895 | 0.5916 | 1.48071 | 85.29 | 0.53623 | 20.6 |
| 12 | −81.6839 | DD[12] | | | | |
| 13 (St) | ∞ | 1.6001 | | | | |
| *14 | 23.7542 | 4.3839 | 1.68948 | 31.02 | 0.59874 | |
| *15 | −101.0414 | 4.4633 | | | | |
| 16 | 28.1997 | 0.6556 | 1.85451 | 25.15 | 0.61031 | |
| 17 | 13.9302 | 3.2333 | 1.43700 | 95.10 | 0.53364 | |
| 18 | 32.7083 | 1.3277 | | | | |
| 19 | −9166.7703 | 0.5800 | 1.85451 | 25.15 | 0.61031 | |
| 20 | 19.5404 | 3.9995 | 1.49700 | 81.61 | 0.53887 | |
| 21 | −124.0912 | 1.2550 | | | | |
| *22 | 23.7044 | 5.8911 | 1.62087 | 63.83 | 0.54330 | |
| *23 | −21.5294 | DD[23] | | | | |
| 24 | 335.4437 | 2.0002 | 1.98613 | 16.48 | 0.66558 | |
| 25 | −58.4915 | 0.5800 | 1.83400 | 37.16 | 0.57759 | 21.6 |
| 26 | 24.8295 | DD[26] | | | | |
| *27 | ∞ | 2.6508 | 1.51633 | 64.06 | 0.53345 | |
| *28 | −79.0419 | DD[28] | | | | |

TABLE 20
Example 7

| | Wide | Middle | Tele |
|---|---|---|---|
| Zr | 1.0 | 2.1 | 3.2 |
| f | 16.49 | 33.98 | 53.40 |
| Bf | 19.28 | 16.53 | 14.40 |
| FNo. | 2.88 | 2.88 | 2.88 |
| 2ω[°] | 87.4 | 44.8 | 29.2 |
| DD[5] | 0.80 | 17.57 | 29.24 |
| DD[12] | 20.96 | 4.61 | 1.00 |
| DD[23] | 1.40 | 3.83 | 2.36 |
| DD[26] | 5.99 | 14.70 | 26.85 |
| DD[28] | 19.28 | 16.53 | 14.40 |

TABLE 21
Example 7

| Sn | 6 | 7 | 14 | 15 |
|---|---|---|---|---|
| KA | 1.0000000E+00 | 1.0000000E+00 | 1.0000000E+00 | 1.0000000E+00 |
| A3 | 2.5699607E−20 | 0.0000000E+00 | 1.8731492E−20 | 0.0000000E+00 |
| A4 | 8.5108770E−05 | 7.1352262E−05 | −1.8005198E−05 | −2.8937128E−06 |
| A5 | −1.3971422E−05 | −1.5226278E−05 | −4.2614115E−07 | −2.9601559E−07 |
| A6 | 6.5761585E−07 | 9.1043752E−07 | −1.1473488E−07 | −9.9424476E−08 |
| A7 | 3.2691799E−08 | −5.7431283E−09 | 3.5980176E−08 | 3.9796222E−08 |
| A8 | −3.3827429E−09 | −4.1532519E−09 | −1.8017115E−09 | −1.9977380E−09 |
| A9 | 3.1269026E−11 | 5.0358022E−10 | −2.3058143E−10 | −2.5325125E−10 |
| A10 | 2.3555941E−12 | −2.2969182E−11 | 2.1445688E−11 | 2.3793255E−11 |

| Sn | 22 | 23 | 27 | 28 |
|---|---|---|---|---|
| KA | 1.0000000E+00 | 1.0000000E+00 | 1.0000000E+00 | 1.0000000E+00 |
| A3 | −1.8731492E−20 | −4.6828730E−21 | 0.0000000E+00 | −5.2879850E−20 |
| A4 | −3.1015588E−05 | 7.9212979E−06 | −1.2456693E−05 | 1.3586913E−05 |
| A5 | −1.3525066E−06 | 6.0080370E−07 | −1.4954923E−06 | −6.4377034E−06 |
| A6 | 3.5175510E−07 | −1.0457975E−07 | −3.4138234E−07 | 1.7517650E−07 |
| A7 | −3.6028763E−08 | −1.3128633E−09 | 2.5798985E−08 | 1.7743560E−08 |
| A8 | −7.5511228E−11 | 4.2141224E−10 | 1.2183924E−09 | −1.0462961E−09 |
| A9 | 2.0665774E−10 | −1.5253210E−11 | −1.5786389E−10 | −2.2286137E−11 |
| A10 | −8.8385568E−12 | −2.4314061E−13 | −7.0830565E−13 | −1.1746029E−12 |

### Example 8

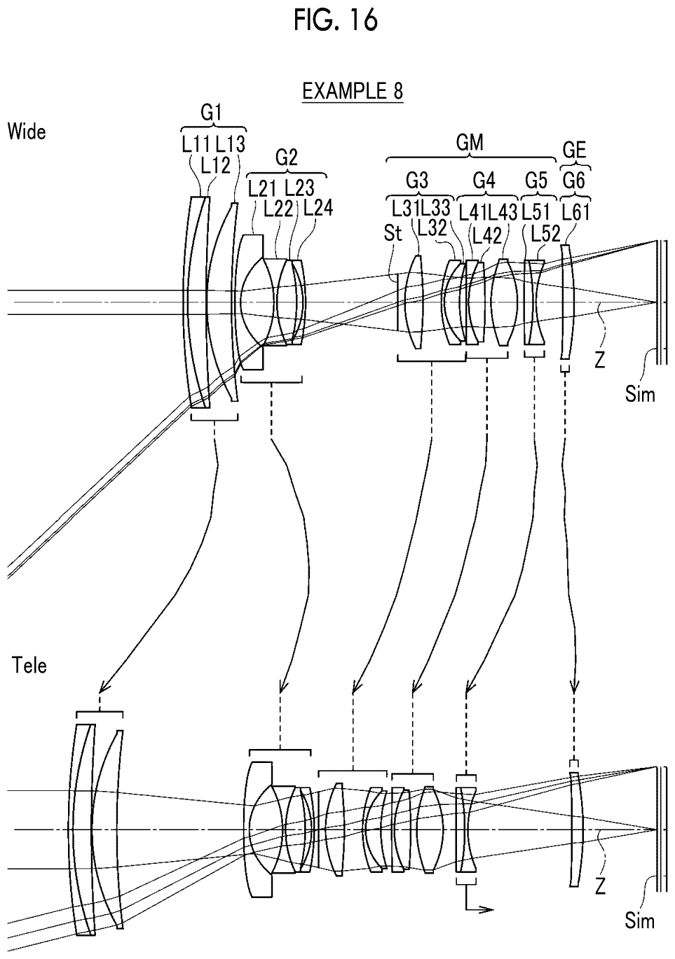

A configuration and a moving path of a zoom lens of Example 8 are illustrated in FIG. 16. The zoom lens of Example 8 consists of, in order from the object side to the image side, the first lens group G1 having a positive refractive power, the second lens group G2 having a negative refractive power, the third lens group G3 having a positive refractive power, the fourth lens group G4 having a positive refractive power, the fifth lens group G5 having a negative refractive power, and the sixth lens group G6 having a positive refractive power. The intermediate group GM consists of the third lens group G3, the fourth lens group G4, and the fifth lens group G5. The final lens group GE consists of the sixth lens group G6. During the zooming from the wide angle end to the telephoto end, all lens groups move along the optical axis Z by changing spacings between adjacent lens groups. The focus group consists of the fifth lens group G5. During the focusing from the infinite distance object to the nearest object, the focus group moves to the image side.

The first lens group G1 consists of three lenses including the lenses L11 to L13 in order from the object side to the image side. The second lens group G2 consists of four lenses including the lenses L21 to L24 in order from the object side to the image side. The third lens group G3 consists of the aperture stop St and three lenses including the lenses L31 to L33 in order from the object side to the image side. The fourth lens group G4 consists of three lenses including the lenses L41 to L43 in order from the object side to the image side. The fifth lens group G5 consists of two lenses including the lenses L51 and L52 in order from the object side to the image side. The sixth lens group G6 consists of one lens that is the lens L61.

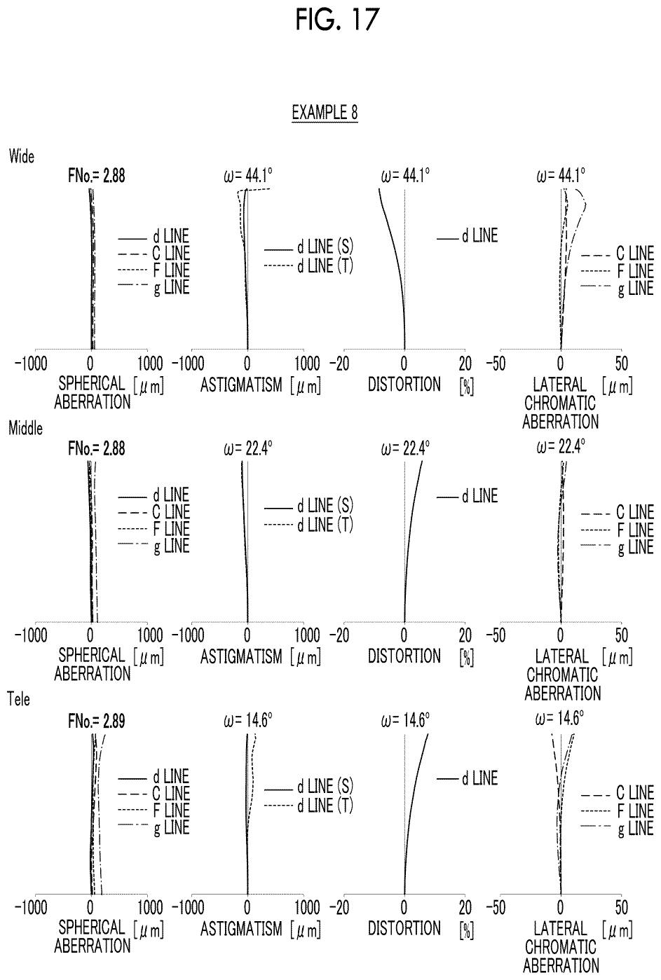

For the zoom lens of Example 8, Table 22 shows basic lens data, Table 23 shows specifications and a variable surface spacing, Table 24 shows aspherical coefficients, and FIG. 17 illustrates each aberration diagram.

TABLE 22
Example 8

| Sn | R | D | Nd | νd | θgF | DA |
|---|---|---|---|---|---|---|
| 1 | 163.8646 | 1.0480 | 1.84666 | 23.84 | 0.62012 | 52.4 |
| 2 | 78.6501 | 4.2149 | 1.49700 | 81.61 | 0.53887 | |
| 3 | 362.4152 | 0.1498 | | | | |
| 4 | 48.3645 | 5.6698 | 1.72916 | 54.67 | 0.54534 | |
| 5 | 194.9665 | DD[5] | | | | |
| *6 | 168.3265 | 1.2800 | 1.81000 | 40.99 | 0.56996 | |
| *7 | 13.7721 | 7.6328 | | | | |
| 8 | −22.6929 | 0.6960 | 1.51478 | 60.63 | 0.54252 | |
| 9 | 23.7576 | 4.4970 | 1.85026 | 32.22 | 0.59378 | |
| 10 | −39.3903 | 1.4473 | | | | |
| 11 | −18.4098 | 0.5918 | 1.49700 | 81.61 | 0.53887 | 20.6 |
| 12 | −50.0892 | DD[12] | | | | |
| 13 (St) | ∞ | 1.6001 | | | | |
| *14 | 23.9436 | 4.1698 | 1.68948 | 31.02 | 0.59874 | |
| *15 | −93.2820 | 4.1841 | | | | |
| 16 | 27.4081 | 0.7053 | 1.85451 | 25.15 | 0.61031 | |
| 17 | 13.2209 | 3.4773 | 1.43700 | 95.10 | 0.53364 | |
| 18 | 31.2677 | DD[18] | | | | |
| 19 | 839.2773 | 0.5800 | 1.85451 | 25.15 | 0.61031 | |
| 20 | 21.5288 | 3.7520 | 1.49700 | 81.61 | 0.53887 | |
| 21 | −120.0047 | 1.3740 | | | | |
| *22 | 24.0686 | 6.0502 | 1.62087 | 63.83 | 0.54330 | |
| *23 | −20.9995 | DD[23] | | | | |
| 24 | 769.1280 | 2.0002 | 1.98613 | 16.48 | 0.66558 | |
| 25 | −53.1377 | 0.7114 | 1.83400 | 37.16 | 0.57759 | 21.6 |
| 26 | 23.9605 | DD[26] | | | | |
| *27 | −301.9949 | 2.5750 | 1.51633 | 64.06 | 0.53345 | |
| *28 | −61.3079 | DD[28] | | | | |

TABLE 23
Example 8

| | Wide | Middle | Tele |
|---|---|---|---|
| Zr | 1.0 | 2.1 | 3.2 |
| f | 16.50 | 33.99 | 53.40 |
| Bf | 18.98 | 18.11 | 16.93 |
| FNo. | 2.88 | 2.88 | 2.89 |
| 2ω[°] | 88.2 | 44.8 | 29.2 |
| DD[5] | 0.80 | 18.31 | 29.04 |
| DD[12] | 20.99 | 4.48 | 1.00 |
| DD[18] | 1.50 | 2.23 | 2.50 |
| DD[23] | 1.55 | 4.44 | 2.96 |
| DD[26] | 6.16 | 11.49 | 23.82 |
| DD[28] | 18.98 | 18.11 | 16.93 |

TABLE 24
Example 8

| Sn | 6 | 7 | 14 | 15 |
|---|---|---|---|---|
| KA | 1.0000000E+00 | 1.0000000E+00 | 1.0000000E+00 | 1.0000000E+00 |
| A3 | −8.3523723E−20 | 3.2583086E−20 | 1.8731492E−20 | 1.8731492E−20 |
| A4 | 1.0551233E−04 | 9.3979389E−05 | −1.8200380E−05 | −3.0984744E−07 |
| A5 | −1.5537084E−05 | −1.6366762E−05 | −3.5925074E−07 | −5.8196120E−07 |
| A6 | 5.8242205E−07 | 7.1011928E−07 | −9.6015250E−08 | −5.3561916E−08 |
| A7 | 4.2379082E−08 | 2.9735218E−08 | 3.7601535E−08 | 4.2917971E−08 |
| A8 | −3.3366153E−09 | −5.6245931E−09 | −2.0006395E−09 | −2.5052465E−09 |
| A9 | 1.1184841E−11 | 3.4467799E−10 | −2.3182240E−10 | −2.5026912E−10 |
| A10 | 2.6850566E−12 | −7.5874873E−12 | 2.2563713E−11 | 2.5372937E−11 |

| Sn | 22 | 23 | 27 | 28 |
|---|---|---|---|---|
| KA | 1.0000000E+00 | 1.0000000E+00 | 1.0000000E+00 | 1.0000000E+00 |
| A3 | −3.7462984E−20 | −8.7803869E−21 | −7.0506467E−20 | −1.7626617E−20 |
| A4 | −2.9624696E−05 | 8.4666483E−06 | −7.0162145E−06 | 1.8612998E−05 |
| A5 | −1.8283925E−06 | 8.9285095E−07 | 2.6263438E−06 | −2.4602671E−06 |
| A6 | 4.3519448E−07 | −1.1724049E−07 | −3.2408758E−07 | 2.1084490E−07 |
| A7 | −3.9267911E−08 | −2.9740268E−09 | 1.1331077E−08 | 1.8083100E−10 |
| A8 | −4.2807469E−10 | 6.7282957E−10 | 1.7251971E−09 | −3.3474610E−10 |
| A9 | 2.5840505E−10 | −9.0266440E−12 | −1.0870945E−10 | 4.0228267E−11 |
| A10 | −1.1130324E−11 | −1.4257972E−12 | −1.9418128E−12 | −4.5389932E−12 |

### Example 9

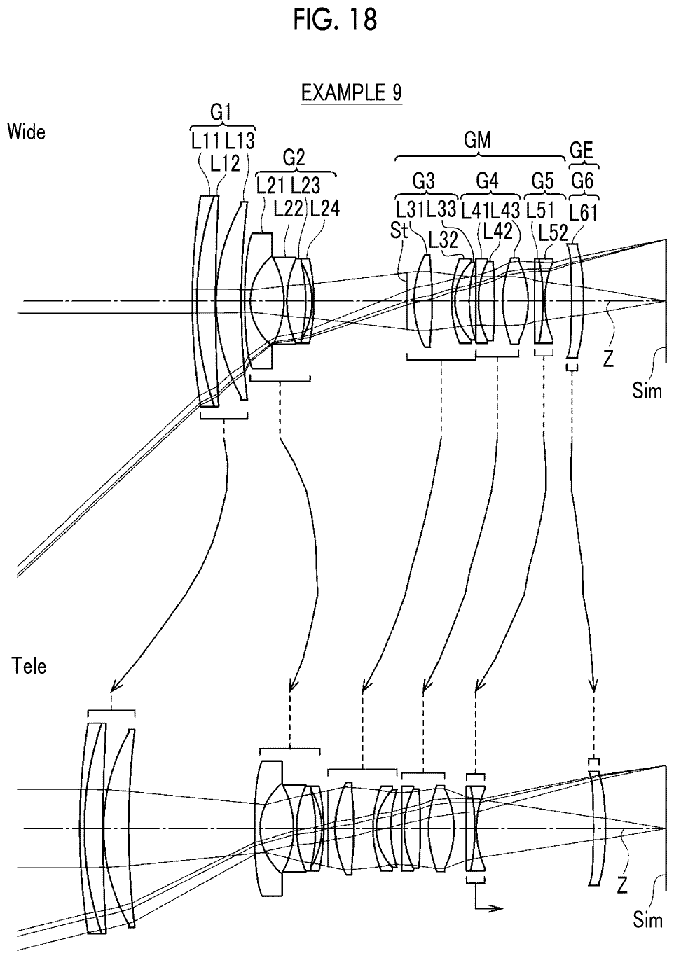

A configuration and a moving path of a zoom lens of Example 9 are illustrated in FIG. 18. The zoom lens of Example 9 consists of, in order from the object side to the image side, the first lens group G1 having a positive refractive power, the second lens group G2 having a negative refractive power, the third lens group G3 having a positive refractive power, the fourth lens group G4 having a positive refractive power, the fifth lens group G5 having a negative refractive power, and the sixth lens group G6 having a positive refractive power. The intermediate group GM consists of the third lens group G3, the fourth lens group G4, and the fifth lens group G5. The final lens group GE consists of the sixth lens group G6. During the zooming from the wide angle end to the telephoto end, all lens groups move along the optical axis Z by changing spacings between adjacent lens groups. The focus group consists of the fifth lens group G5. During the focusing from the infinite distance object to the nearest object, the focus group moves to the image side.

The first lens group G1 consists of three lenses including the lenses L11 to L13 in order from the object side to the image side. The second lens group G2 consists of four lenses including the lenses L21 to L24 in order from the object side to the image side. The third lens group G3 consists of the aperture stop St and three lenses including the lenses L31 to L33 in order from the object side to the image side. The fourth lens group G4 consists of three lenses including the lenses L41 to L43 in order from the object side to the image side. The fifth lens group G5 consists of two lenses including the lenses L51 and L52 in order from the object side to the image side. The sixth lens group G6 consists of one lens that is the lens L61.

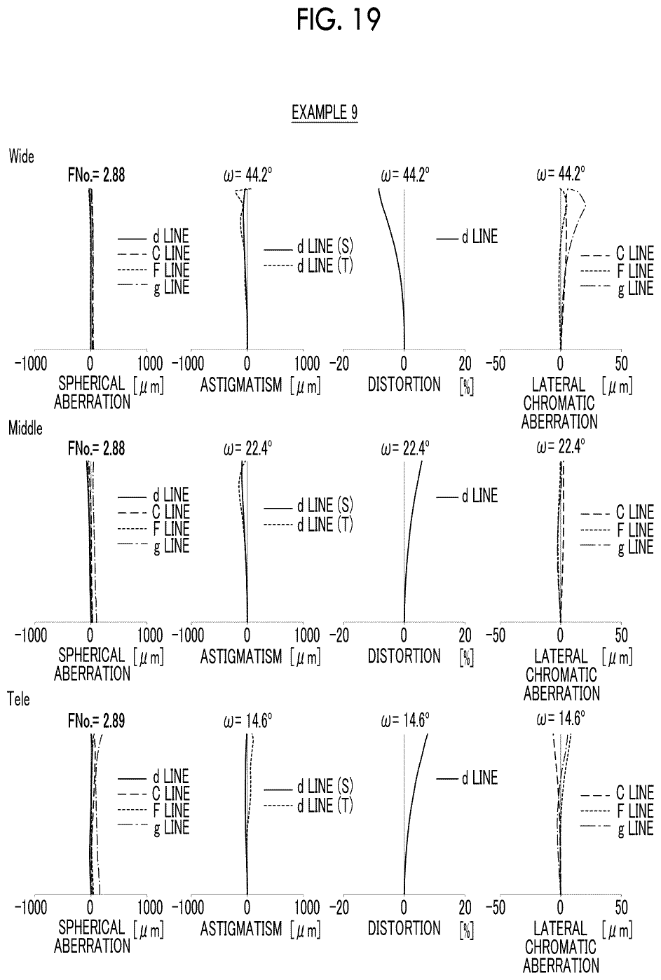

For the zoom lens of Example 9, Table 25 shows basic lens data, Table 26 shows specifications and a variable surface spacing, Table 27 shows aspherical coefficients, and FIG. 19 illustrates each aberration diagram.

TABLE 25
Example 9

| Sn | R | D | Nd | νd | θgF | DA |
|---|---|---|---|---|---|---|
| 1 | 163.4410 | 1.0480 | 1.84666 | 23.84 | 0.62012 | 52.4 |
| 2 | 80.3422 | 4.2770 | 1.49700 | 81.61 | 0.53887 | |
| 3 | 439.7342 | 0.1498 | | | | |
| 4 | 48.1225 | 5.7366 | 1.69680 | 55.53 | 0.54341 | |
| 5 | 199.3192 | DD[5] | | | | |
| *6 | 219.4072 | 1.2800 | 1.81000 | 40.99 | 0.56996 | |
| *7 | 13.9871 | 7.6747 | | | | |
| 8 | −22.4293 | 0.6961 | 1.51478 | 60.63 | 0.54252 | |
| 9 | 25.4340 | 4.3402 | 1.85026 | 32.22 | 0.59378 | |
| 10 | −39.4135 | 1.4244 | | | | |
| 11 | −18.2257 | 0.4080 | 1.43700 | 95.10 | 0.53364 | 20.6 |
| 12 | −49.7007 | DD[12] | | | | |
| 13 (St) | ∞ | 1.5998 | | | | |
| *14 | 24.4557 | 4.1748 | 1.68948 | 31.02 | 0.59874 | |
| *15 | −84.7941 | 4.4132 | | | | |
| 16 | 27.9605 | 0.7799 | 1.85451 | 25.15 | 0.61031 | |
| 17 | 13.3335 | 3.2884 | 1.45650 | 90.27 | 0.53477 | |
| 18 | 30.3971 | DD[18] | | | | |
| 19 | 1195.4201 | 0.5800 | 1.84666 | 23.78 | 0.62054 | |
| 20 | 22.2601 | 3.7073 | 1.49700 | 81.61 | 0.53887 | |
| 21 | −127.3128 | 1.8673 | | | | |
| *22 | 24.5430 | 5.8540 | 1.62087 | 63.83 | 0.54330 | |
| *23 | −21.0897 | DD[23] | | | | |
| 24 | 555.9447 | 2.0000 | 1.98613 | 16.48 | 0.66558 | |
| 25 | −52.8071 | 0.4000 | 1.83400 | 37.16 | 0.57759 | 21.6 |
| 26 | 24.0827 | DD[26] | | | | |
| *27 | −398.4216 | 2.7962 | 1.51633 | 64.06 | 0.53345 | |
| *28 | −66.6576 | DD[28] | | | | |

TABLE 26
Example 9

| | Wide | Middle | Tele |
|---|---|---|---|
| Zr | 1.0 | 2.1 | 3.2 |
| f | 16.50 | 33.99 | 53.40 |
| Bf | 18.86 | 16.36 | 13.85 |
| FNo. | 2.88 | 2.88 | 2.89 |
| 2ω[°] | 88.4 | 44.8 | 29.2 |
| DD[5] | 0.80 | 18.13 | 28.82 |
| DD[12] | 21.22 | 4.40 | 1.00 |
| DD[18] | 1.50 | 2.31 | 2.50 |
| DD[23] | 1.41 | 4.36 | 2.74 |
| DD[26] | 6.10 | 13.05 | 26.77 |
| DD[28] | 18.86 | 16.36 | 13.85 |

TABLE 27
Example 9

| Sn | 6 | 7 | 14 | 15 |
|---|---|---|---|---|
| KA | 1.0000000E+00 | 1.0000000E+00 | 1.0000000E+00 | 1.0000000E+00 |
| A3 | 6.4249018E−20 | 2.2808160E−19 | 0.0000000E+00 | 0.0000000E+00 |
| A4 | 1.0653762E−04 | 9.4687737E−05 | −1.7028775E−05 | 1.0320599E−06 |
| A5 | −1.5691839E−05 | −1.6554445E−05 | −2.0079091E−07 | −3.2813557E−07 |
| A6 | 5.8035236E−07 | 6.8221065E−07 | −1.1524112E−07 | −7.5618815E−08 |
| A7 | 4.3361071E−08 | 3.1567081E−08 | 3.8774518E−08 | 4.2125219E−08 |
| A8 | −3.3502141E−09 | −5.3175130E−09 | −2.0030824E−09 | −2.4396885E−09 |
| A9 | 9.0787863E−12 | 3.2816638E−10 | −2.4155755E−10 | −2.5006030E−10 |
| A10 | 2.7254511E−12 | −8.0737743E−12 | 2.4047405E−11 | 2.6445883E−11 |

| Sn | 22 | 23 | 27 | 28 |
|---|---|---|---|---|
| KA | 1.0000000E+00 | 1.0000000E+00 | 1.0000000E+00 | 1.0000000E+00 |
| A3 | 0.0000000E+00 | −1.2877901E−20 | 0.0000000E+00 | 8.8133083E−20 |
| A4 | −2.7760940E−05 | 1.0562344E−05 | −6.8341725E−07 | 2.7215629E−05 |
| A5 | −1.7390720E−06 | 7.6648499E−07 | −7.9664878E−07 | −5.7061723E−06 |
| A6 | 4.0375158E−07 | −1.2374078E−07 | −2.0764866E−07 | 2.8164742E−07 |
| A7 | −3.7947223E−08 | −4.4532726E−10 | 3.0862730E−08 | 2.2652041E−08 |
| A8 | −2.4564843E−10 | 6.1289397E−10 | −1.0897738E−10 | −2.1217385E−09 |
| A9 | 2.4674787E−10 | −1.9767683E−11 | −1.5858532E−10 | −2.4041257E−11 |
| A10 | −1.1142844E−11 | −7.8576264E−13 | 3.7398006E−12 | 1.7474637E−12 |

### Example 10

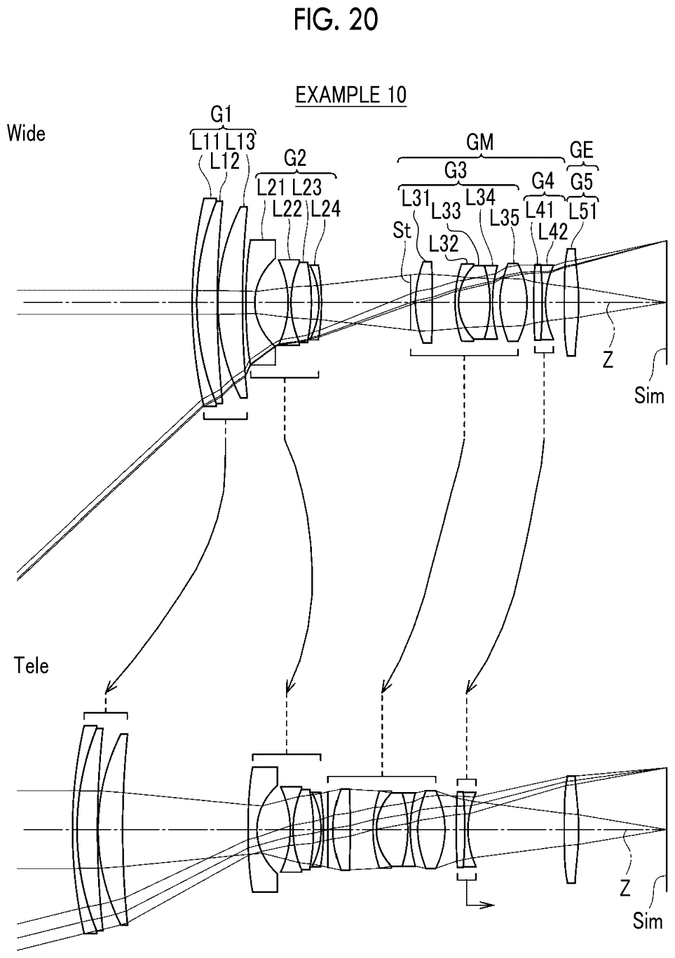

A configuration and a moving path of a zoom lens of Example 10 are illustrated in FIG. 20. The zoom lens of Example 10 consists of, in order from the object side to the image side, the first lens group G1 having a positive refractive power, the second lens group G2 having a negative refractive power, the third lens group G3 having a positive refractive power, the fourth lens group G4 having a negative refractive power, and the fifth lens group G5 having a positive refractive power. The intermediate group GM consists of the third lens group G3 and the fourth lens group G4. The final lens group GE consists of the fifth lens group G5. During the zooming from the wide angle end to the telephoto end, the first lens group G1, the second lens group G2, the third lens group G3, and the fourth lens group G4 move along the optical axis Z by changing spacings between adjacent lens groups, and the fifth lens group G5 is fixed with respect to the image plane Sim. The focus group consists of the fourth lens group G4. During the focusing from the infinite distance object to the nearest object, the focus group moves to the image side.

The first lens group G1 consists of three lenses including the lenses L11 to L13 in order from the object side to the image side. The second lens group G2 consists of four lenses including the lenses L21 to L24 in order from the object side to the image side. The third lens group G3 consists of the aperture stop St and five lenses including the lenses L31 to L35 in order from the object side to the image side. The fourth lens group G4 consists of two lenses including the lenses L41 and L42 in order from the object side to the image side. The fifth lens group G5 consists of one lens that is the lens L51.

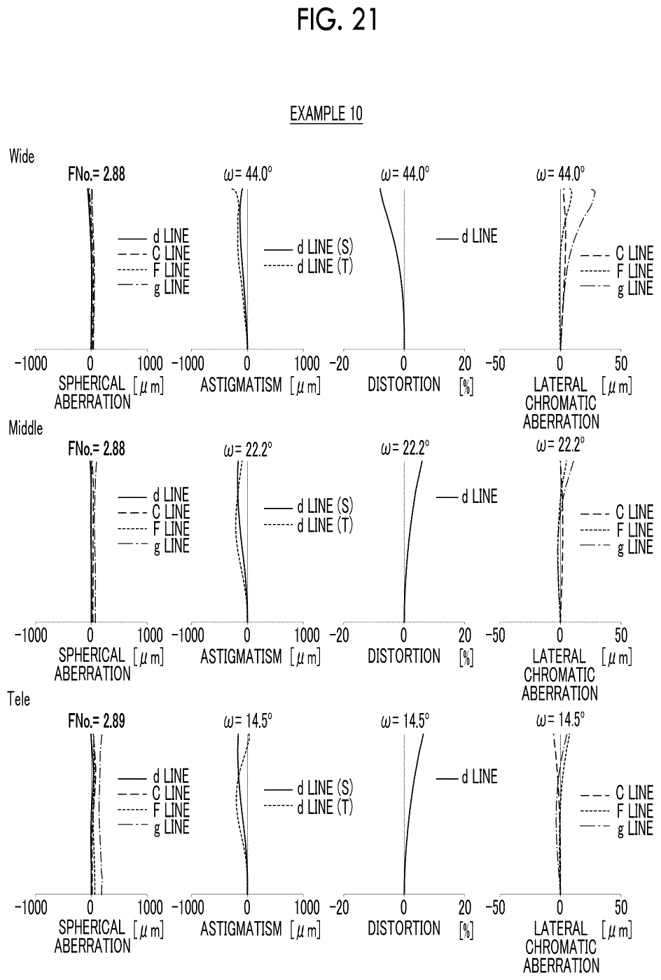

For the zoom lens of Example 10, Table 28 shows basic lens data, Table 29 shows specifications and a variable surface spacing, Table 30 shows aspherical coefficients, and FIG. 21 illustrates each aberration diagram.

TABLE 28
Example 10

| Sn | R | D | Nd | νd | θgF | DA |
|---|---|---|---|---|---|---|
| 1 | 115.2643 | 1.0500 | 1.84666 | 23.78 | 0.61923 | 52.4 |
| 2 | 66.7837 | 4.6662 | 1.49700 | 81.61 | 0.53887 | |
| 3 | 231.5849 | 0.1500 | | | | |
| 4 | 52.0310 | 5.6207 | 1.72916 | 54.67 | 0.54534 | |
| 5 | 228.5667 | DD[5] | | | | |
| *6 | 164.4696 | 2.0345 | 1.85135 | 40.10 | 0.56954 | |
| *7 | 13.6109 | 7.6337 | | | | |
| 8 | −24.2751 | 0.6466 | 1.51823 | 58.96 | 0.54420 | |
| 9 | 24.4294 | 4.6714 | 1.95375 | 32.32 | 0.59015 | |
| 10 | −49.3356 | 1.7333 | | | | |
| 11 | −19.6883 | 0.5751 | 1.49700 | 81.61 | 0.53887 | 20.6 |
| 12 | −54.8048 | DD[12] | | | | |
| 13 (St) | ∞ | 1.1000 | | | | |
| *14 | 24.5368 | 3.8529 | 1.68948 | 31.02 | 0.59874 | |
| *15 | −703.8924 | 5.2150 | | | | |
| 16 | 28.6078 | 0.7839 | 1.85451 | 25.15 | 0.61031 | |
| 17 | 12.6473 | 7.2014 | 1.49700 | 81.61 | 0.53887 | |
| 18 | −29.4719 | 0.5639 | 1.67300 | 38.26 | 0.57580 | |
| 19 | 33.2364 | 1.7018 | | | | |
| *20 | 20.1830 | 6.2191 | 1.61881 | 63.85 | 0.54182 | |
| *21 | −20.8987 | DD[21] | | | | |
| 22 | 160.7315 | 1.9780 | 1.95906 | 17.47 | 0.65993 | |
| 23 | −102.4099 | 0.7234 | 1.83400 | 37.21 | 0.57834 | 21.6 |
| 24 | 22.0586 | DD[24] | | | | |
| *25 | 468.3881 | 3.2968 | 1.51633 | 64.06 | 0.53345 | |
| *26 | −55.6475 | 20.1112 | | | | |

TABLE 29
Example 10

| | Wide | Middle | Tele |
|---|---|---|---|
| Zr | 1.0 | 2.1 | 3.2 |
| f | 16.49 | 33.98 | 53.39 |
| Bf | 20.11 | 20.11 | 20.11 |
| FNo. | 2.88 | 2.88 | 2.89 |
| 2ω[°] | 88.0 | 44.4 | 29.0 |
| DD[5] | 0.80 | 17.58 | 28.69 |
| DD[12] | 20.28 | 4.87 | 1.00 |
| DD[21] | 1.53 | 3.70 | 2.59 |
| DD[24] | 4.29 | 11.23 | 22.03 |

TABLE 30
Example 10

| Sn | 6 | 7 | 14 | 15 |
|---|---|---|---|---|
| KA | 1.0000000E+00 | 6.6103793E−01 | 1.0000000E+00 | 1.0000000E+00 |
| A3 | 0.0000000E+00 | −6.5166171E−20 | 2.6341161E−21 | −9.3657460E−21 |
| A4 | 4.4253288E−05 | 4.2123814E−05 | −3.2035780E−05 | −2.5704246E−05 |
| A5 | −5.0681472E−06 | −6.1586460E−06 | 6.0257231E−07 | 5.6483538E−07 |
| A6 | −2.1726497E−09 | 6.4841989E−07 | 1.7646683E−07 | 1.7694966E−07 |
| A7 | 2.8721437E−08 | −6.9607689E−08 | −5.3522460E−09 | 4.3279330E−09 |
| A8 | −8.5009248E−10 | 2.9849526E−10 | −2.4959544E−09 | −2.5257364E−09 |
| A9 | −5.2248160E−11 | 6.9434627E−10 | 4.4362450E−13 | −1.0046878E−10 |
| A10 | 2.3007802E−12 | −3.5909520E−11 | 1.8345863E−11 | 2.4800319E−11 |
| Sn | 20 | 21 | 25 | 26 |
| KA | 1.0000000E+00 | 1.0000000E+00 | 1.0000000E+00 | 1.0000000E+00 |
| A3 | 2.8097238E−20 | 1.8731492E−20 | 3.5253233E−20 | 0.0000000E+00 |
| A4 | −5.3297202E−05 | 1.0020840E−05 | 2.0928704E−05 | 3.1297652E−05 |
| A5 | −3.0363742E−07 | −3.2271741E−07 | −2.8522640E−07 | −1.5549716E−06 |
| A6 | 1.7156031E−07 | 1.7901443E−07 | −5.3870538E−08 | −6.6169569E−08 |
| A7 | −2.4554486E−08 | −3.2220297E−08 | 2.1440555E−08 | 3.4901008E−08 |
| A8 | 9.7375690E−10 | −2.1555124E−12 | −7.8754832E−10 | −1.4675652E−09 |
| A9 | 6.0971915E−11 | 2.2371965E−10 | −9.4185926E−11 | −1.0082319E−10 |
| A10 | −5.3938119E−12 | −1.1480643E−11 | 5.1065086E−12 | 5.7694659E−12 |

Tables 31 and 32 show the corresponding values of Conditional Expressions (1) to (26) of the zoom lenses of Examples 1 to 10. Preferable ranges of the conditional expressions may be set using the corresponding values of the examples shown in Tables 31 and 32 as the upper limits and the lower limits of the conditional expressions.

TABLE 31

| Expression | | | | | | |
|---|---|---|---|---|---|---|
| Number | | Example 1 | Example 2 | Example 3 | Example 4 | Example 5 |
| (1) | fw/f1 | 0.171 | 0.171 | 0.185 | 0.178 | 0.180 |
| (2) | Fnot/(ft/fw) | 0.891 | 0.891 | 0.891 | 0.891 | 0.891 |
| (3) | Bfw/(ft × tan ωt) | 1.351 | 1.457 | 1.657 | 1.486 | 1.475 |
| (4) | TLt/(ft × tan ωt) | 10.217 | 10.264 | 10.055 | 10.225 | 10.219 |
| (5) | dMEt/dMEw | 3.113 | 3.794 | 5.852 | 3.766 | 4.133 |
| (6) | (R2f + R2r)/(R2f − R2r) | 0.687 | 0.716 | 0.724 | 0.510 | 0.535 |
| (7) | Nd1r | 1.72915 | 1.72916 | 1.78800 | 1.72916 | 1.75500 |
| (8) | νd1r | 54.64 | 54.67 | 47.37 | 54.67 | 52.32 |
| (9) | Nd2r | 1.49700 | 1.49700 | 1.61800 | 1.49700 | 1.55032 |
| (10) | νd2r | 81.61 | 81.61 | 63.39 | 81.61 | 75.50 |
| (11) | fw/(ft × tan ωt) | 1.245 | 1.243 | 1.243 | 1.242 | 1.242 |
| (12) | DDL1STw/TLw | 0.457 | 0.455 | 0.459 | 0.451 | 0.452 |
| (13) | d1/DA1 | 0.020 | 0.020 | 0.020 | 0.020 | 0.020 |
| (14) | d2r/DA2r | 0.029 | 0.029 | 0.029 | 0.029 | 0.029 |
| (15) | dffr/DAffr | 0.027 | 0.030 | 0.027 | 0.034 | 0.036 |
| (16) | f1/fE | 0.982 | 0.952 | 0.254 | 0.661 | 0.654 |
| (17) | fw/f2 | −0.930 | −0.930 | −0.959 | −0.971 | −0.965 |
| (18) | f2/ff | 0.528 | 0.531 | 0.432 | 0.512 | 0.514 |
| (19) | fw/fMp | 0.768 | 0.760 | 0.738 | 0.761 | 0.756 |
| (20) | ft/fMp | 2.485 | 2.458 | 2.387 | 2.463 | 2.445 |
| (21) | Ndfp − Ndfn | −0.41750 | −0.41750 | −0.41750 | −0.41750 | −0.41750 |
| (22) | νdfp − νdfn | 69.97 | 69.94 | 69.94 | 69.94 | 69.94 |
| (23) | θgFfp − θgFfn | −0.07544 | −0.07667 | −0.07667 | −0.07667 | −0.07667 |
| (24) | Ndrp − Ndrn | −0.35751 | −0.35751 | −0.35751 | −0.41750 | −0.41750 |
| (25) | νdrp − νdrn | 56.45 | 56.45 | 56.45 | 69.94 | 69.94 |
| (26) | θgFrp − θgFrn | −0.07144 | −0.07144 | −0.07144 | −0.07667 | −0.07667 |

TABLE 32

| Expression | | | | | | |
|---|---|---|---|---|---|---|
| Number | | Example 6 | Example 7 | Example 8 | Example 9 | Example 10 |
| (1) | fw/f1 | 0.185 | 0.180 | 0.178 | 0.178 | 0.179 |
| (2) | Fnot/(ft/fw) | 0.891 | 0.891 | 0.891 | 0.891 | 0.891 |
| (3) | Bfw/(ft × tan ωt) | 1.349 | 1.450 | 1.428 | 1.419 | 1.499 |
| (4) | TLt/(ft × tan ωt) | 10.088 | 10.086 | 10.148 | 10.112 | 10.137 |
| (5) | dMEt/dMEw | 3.900 | 4.483 | 3.867 | 4.387 | 5.135 |
| (6) | (R2f + R2r)/(R2f − R2r) | 0.317 | 0.150 | 0.541 | 0.631 | 0.500 |
| (7) | Nd1r | 1.72916 | 1.77250 | 1.72916 | 1.69680 | 1.72916 |
| (8) | νd1r | 54.67 | 49.60 | 54.67 | 55.53 | 54.67 |
| (9) | Nd2r | 1.49700 | 1.48071 | 1.49700 | 1.43700 | 1.49700 |
| (10) | νd2r | 81.61 | 85.29 | 81.61 | 95.10 | 81.61 |
| (11) | fw/(ft × tan ωt) | 1.243 | 1.243 | 1.243 | 1.243 | 1.230 |
| (12) | DDL1STw/TLw | 0.451 | 0.453 | 0.452 | 0.453 | 0.460 |
| (13) | d1/DA1 | 0.020 | 0.020 | 0.020 | 0.020 | 0.020 |
| (14) | d2r/DA2r | 0.029 | 0.029 | 0.029 | 0.020 | 0.028 |
| (15) | dffr/DAffr | 0.034 | 0.027 | 0.033 | 0.019 | 0.033 |
| (16) | f1/fE | 0.597 | 0.599 | 0.622 | 0.598 | 0.954 |
| (17) | fw/f2 | −0.942 | −0.930 | −0.965 | −0.949 | −0.938 |
| (18) | f2/ff | 0.487 | 0.495 | 0.522 | 0.519 | 0.533 |
| (19) | fw/fMp | 0.747 | 0.747 | 0.762 | 0.753 | 0.761 |
| (20) | ft/fMp | 2.419 | 2.417 | 2.467 | 2.437 | 2.462 |
| (21) | Ndfp − Ndfn | −0.41750 | −0.41750 | −0.41750 | −0.39801 | −0.35751 |
| (22) | νdfp − νdfn | 69.94 | 69.94 | 69.94 | 65.11 | 56.46 |
| (23) | θgFfp − θgFfn | −0.07667 | −0.07667 | −0.07667 | −0.07554 | −0.07144 |
| (24) | Ndrp − Ndrn | −0.35751 | −0.35751 | −0.41750 | −0.39801 | −0.176 |
| (25) | νdrp − νdrn | 56.45 | 56.45 | 69.94 | 65.11 | 43.35 |
| (26) | θgFrp − θgFrn | −0.07144 | −0.07144 | −0.07667 | −0.07554 | −0.03693 |

The zoom lenses of Examples 1 to 10 implement an F-number smaller than 3 at the telephoto end and a small F-number in the entire magnification range. The zoom lenses of Examples 1 to 10 favorably correct various aberrations in the entire magnification range while being configured to be reduced in size and thus, maintain high optical performance.

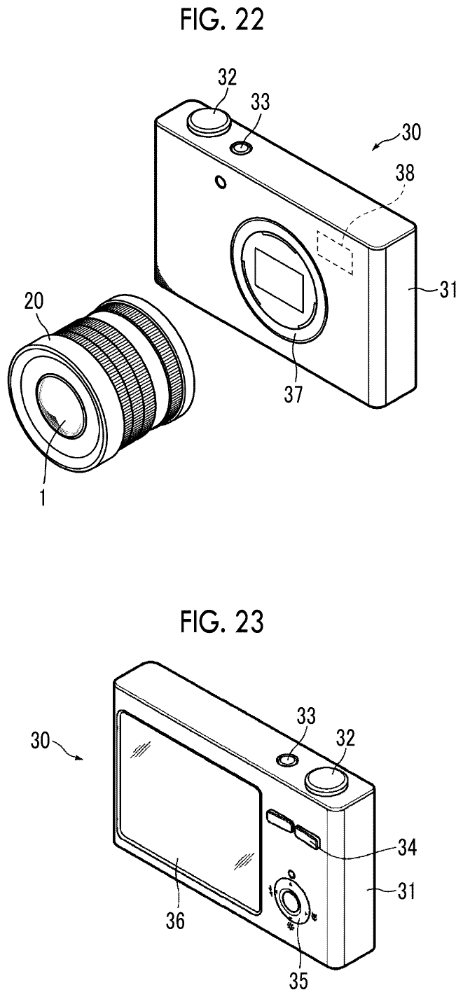

Next, an imaging apparatus according to the embodiment of the present disclosure will be described. FIGS. 22 and 23 illustrate external views of a camera 30 that is the imaging apparatus according to one embodiment of the present disclosure. FIG. 22 illustrates a perspective view of the camera 30 seen from its front surface side, and FIG. 23 illustrates a perspective view of the camera 30 seen from its rear surface side. The camera 30 is a so-called mirrorless type digital camera on which an interchangeable lens 20 can be attachably and detachably mounted. The interchangeable lens 20 is configured to include a zoom lens 1 according to one embodiment of the present disclosure accommodated in a lens barrel.

The camera 30 comprises a camera body 31. A shutter button 32 and a power button 33 are provided on an upper surface of the camera body 31. An operator 34, an operator 35, and a display unit 36 are provided on a rear surface of the camera body 31. The display unit 36 can display a captured image and an image within an angle of view before imaging.

An imaging aperture on which light from an imaging target is incident is provided in a center portion of a front surface of the camera body 31. A mount 37 is provided at a position corresponding to the imaging aperture, and the interchangeable lens 20 is mounted on the camera body 31 through the mount 37.

An imaging element 38 is provided in the camera body 31. The imaging element 38 outputs an imaging signal corresponding to a subject image formed by the interchangeable lens 20. For example, a charge coupled device (CCD) or a complementary metal oxide semiconductor (CMOS) is used as the imaging element 38. A signal processing circuit (not illustrated), a recording medium (not illustrated), and the like are provided in the camera body 31. The signal processing circuit generates an image by processing the imaging signal output from the imaging element 38. The generated image is recorded on the recording medium. In the camera 30, a static image or a video can be captured by pressing the shutter button 32, and image data obtained by this capturing is recorded on the recording medium.

While the disclosed technology has been described above using the embodiment and the examples, the disclosed technology is not limited to the embodiment and the examples and can be subjected to various modifications. For example, the curvature radius, the surface spacing, the refractive index, the Abbe number, and the aspherical coefficient of each lens are not limited to the values shown in each example and may have other values.

In addition, the imaging apparatus according to the embodiment of the present disclosure is not limited to the above example and can have various aspects of, for example, a camera of a type other than a mirrorless type, a film camera, a video camera, and a security camera.

The following appendices are further disclosed with respect to the embodiment and the examples described above.

### Appendix 1

A zoom lens consisting of, in order from an object side to an image side, a first lens group having a positive refractive power, a second lens group having a negative refractive power, an intermediate group, and a final lens group having a positive refractive power, in which the intermediate group consists of two or three lens groups, during zooming, a spacing between the first lens group and the second lens group changes, a spacing between the second lens group and the intermediate group changes, a spacing between the intermediate group and the final lens group changes, and all spacings between adjacent lens groups in the intermediate group change, an aperture stop is disposed between a lens surface of the second lens group closest to the image side and a lens surface of the final lens group closest to the object side, the first lens group includes, in consecutive order from a position closest to the object side to the image side, a first lens that is a negative lens having a convex surface on the object side, and a second lens that is a positive lens, and in a case where a focal length of an entire system in a state where an infinite distance object is in focus at a wide angle end is denoted by fw, a focal length of the first lens group is denoted by f1, an open F-Number in a state where the infinite distance object is in focus at a telephoto end is denoted by Fnot, a focal length of the entire system in the state where the infinite distance object is in focus at the telephoto end is denoted by ft, a back focus of the entire system as an air conversion distance at the wide angle end is denoted by Bfw, a maximum half angle of view in the state where the infinite distance object is in focus at the telephoto end is denoted by ωt, and a sum of the back focus of the entire system as the air conversion distance and a distance on an optical axis from a surface of the first lens on the object side to a lens surface of the final lens group closest to the image side in the state where the infinite distance object is in focus at the telephoto end is denoted by TLt, Conditional Expressions (1), (2), (3), and (4) are satisfied, which are represented by

$$0 < fw / f 1 < 0.3 \qquad ( 1 )$$

$$0.5 < Fnot / ( ft / fw ) < 1.3 \qquad ( 2 )$$

$$0.15 < Bfw / ( ft \times tan ω t ) < 2 \qquad ( 3 )$$

$$7 < TLt / ( ft \times tan ω t ) < 11. \qquad ( 4 )$$

### Appendix 2

The zoom lens according to Appendix 1, in which, in a case where a spacing on the optical axis between the intermediate group and the final lens group in the state where the infinite distance object is in focus at the telephoto end is denoted by dMEt, and a spacing on the optical axis between the intermediate group and the final lens group in the state where the infinite distance object is in focus at the wide angle end is denoted by dMEw, Conditional Expression (5) is satisfied, which is represented by

$$2 < dMEt / dMEw < 10. \qquad ( 5 )$$

### Appendix 3

The zoom lens according to Appendix 1 or 2, in which, in a case where a paraxial curvature radius of a lens surface of the second lens group closest to the object side is denoted by R2f, and a paraxial curvature radius of the lens surface of the second lens group closest to the image side is denoted by R2r, Conditional Expression (6) is satisfied, which is represented by

$$- 0.5 < ( R 2 f + R 2 r ) / ( R 2 f - R 2 r ) < 2. \qquad ( 6 )$$

### Appendix 4

The zoom lens according to any one of Appendices 1 to 3, in which, in a case where a refractive index with respect to a d line for a lens closest to the image side in the first lens group is denoted by Nd1r, an Abbe number based on the d line for the lens closest to the image side in the first lens group is denoted by vd1r, a refractive index with respect to a d line for a lens closest to the image side in the second lens group is denoted by Nd2r, and an Abbe number based on the d line for the lens closest to the image side in the second lens group is denoted by vd2r, Conditional Expressions (7), (8), (9), and (10) are satisfied, which are represented by

$$1.65 < Nd 1 r < 1.8 \qquad ( 7 )$$

$$45 < vd 1 r < 60 \qquad ( 8 )$$

$$1.4 < Nd 2 r < 1 \text{.65} \qquad ( 9 )$$

$$60 < vd 2 r < 100. \qquad ( 10 )$$

### Appendix 5

The zoom lens according to any one of Appendices 1 to 4, in which Conditional Expression (11) is satisfied, which is represented by

$$1 < fw / ( ft \times tan ω t ) < 1.45 . \qquad ( 11 )$$

### Appendix 6

The zoom lens according to any one of Appendices 1 to 5, in which, in a case where a distance on the optical axis from the surface of the first lens on the object side to the aperture stop in the state where the infinite distance object is in focus at the wide angle end is denoted by DDL1STw, and a sum of the back focus of the entire system as the air conversion distance and a distance on the optical axis from the surface of the first lens on the object side to the lens surface of the final lens group closest to the image side in the state where the infinite distance object is in focus at the wide angle end is denoted by TLw, Conditional Expression (12) is satisfied, which is represented by

$$0 < DDL 1 STw / TLw < 0 \text{.65} . \qquad ( 12 )$$

### Appendix 7

The zoom lens according to any one of Appendices 1 to 6, in which, in a case where a center thickness of the first lens is denoted by d1, and an outer diameter of the first lens is denoted by DA1, Conditional Expression (13) is satisfied, which is represented by

$$0.01 < d1 / DA 1 < 0 \text{.035} . \qquad ( 13 )$$

### Appendix 8

The zoom lens according to any one of Appendices 1 to 7, in which, in a case where a center thickness of a negative lens closest to the image side among negative lenses included in the second lens group is denoted by d2r, and an outer diameter of the negative lens closest to the image side among the negative lenses included in the second lens group is denoted by DA2r, Conditional Expression (14) is satisfied, which is represented by

$$0.01 < d 2 r / DA 2 r < 0 \text{.04} . \qquad ( 14 )$$

### Appendix 9

The zoom lens according to any one of Appendices 1 to 8, in which a focus group that moves along the optical axis during focusing is provided, the focus group includes at least one negative lens, and in a case where a center thickness of a negative lens closest to the image side among negative lenses included in the focus group is denoted by dffr, and an outer diameter of the negative lens closest to the image side among the negative lenses included in the focus group is denoted by DAffr, Conditional Expression (15) is satisfied, which is represented by

$$0.01 < dffr / DAffr < 0.04 . \qquad ( 15 )$$

### Appendix 10

The zoom lens according to any one of Appendices 1 to 9, in which, in a case where a focal length of the final lens group is denoted by fE, Conditional Expression (16) is satisfied, which is represented by

$$0 < f 1 / fE < 2. \qquad ( 16 )$$

### Appendix 11

The zoom lens according to any one of Appendices 1 to 10, in which, in a case where a focal length of the second lens group is denoted by f2, Conditional Expression (17) is satisfied, which is represented by

$$- 2 < fw / f 2 < - 0.7 . \qquad ( 17 )$$

### Appendix 12

The zoom lens according to any one of Appendices 1 to 11, in which a focus group that moves along the optical axis during focusing is provided, and in a case where a focal length of the second lens group is denoted by f2, and a focal length of the focus group is denoted by ff, Conditional Expression (18) is satisfied, which is represented by

$$0.2 < f 2 / ff < 0.8 . \qquad ( 18 )$$

### Appendix 13

The zoom lens according to any one of Appendices 1 to 12, in which, in a case where a focal length of a lens group having a strongest positive refractive power among the lens groups included in the intermediate group is denoted by fMp, Conditional Expression (19) is satisfied, which is represented by

$$0.4 < fw / fMp < 2. \qquad ( 19 )$$

### Appendix 14

The zoom lens according to any one of Appendices 1 to 13, in which, in a case where a focal length of a lens group having a strongest positive refractive power among the lens groups included in the intermediate group is denoted by fMp, Conditional Expression (20) is satisfied, which is represented by

$$1.5 < ft / fMp < 5. \qquad ( 20 )$$

### Appendix 15

The zoom lens according to any one of Appendices 1 to 14, in which Conditional Expression (1-1) is satisfied, which is represented by

$$0 \text{.1} < fw / f 1 < 0.2 . \qquad ( 1 - 1 )$$

### Appendix 16

The zoom lens according to any one of Appendices 1 to 15, in which the first lens group consists of three lenses.

### Appendix 17

The zoom lens according to any one of Appendices 1 to 16, in which the second lens group consists of four lenses.

### Appendix 18

The zoom lens according to any one of Appendices 1 to 17, in which the first lens group moves during the zooming.

### Appendix 19

The zoom lens according to any one of Appendices 1 to 18, in which the zoom lens includes 14 or more lenses.

### Appendix 20

An imaging apparatus comprising the zoom lens according to any one of Appendices 1 to 19.

What is claimed is:

1. A zoom lens consisting of, in order from an object side to an image side, a first lens group having a positive refractive power, a second lens group having a negative refractive power, an intermediate group, and a final lens group having a positive refractive power,
wherein the intermediate group consists of two or three lens groups,
during zooming, a spacing between the first lens group and the second lens group changes, a spacing between the second lens group and the intermediate group changes, a spacing between the intermediate group and the final lens group changes, and all spacings between adjacent lens groups in the intermediate group change,
an aperture stop is disposed between a lens surface of the second lens group closest to the image side and a lens surface of the final lens group closest to the object side,
the first lens group includes, in consecutive order from a position closest to the object side to the image side, a first lens that is a negative lens having a convex surface on the object side, and a second lens that is a positive lens, and
in a case where a focal length of the zoom lens in a state where an infinite distance object is in focus at a wide angle end is denoted by fw,
a focal length of the first lens group is denoted by f1,
an open F-Number in a state where the infinite distance object is in focus at a telephoto end is denoted by Fnot,
a focal length of the zoom lens in the state where the infinite distance object is in focus at the telephoto end is denoted by ft,
a back focus of the zoom lens as an air conversion distance at the wide angle end is denoted by Bfw,
a maximum half angle of view in the state where the infinite distance object is in focus at the telephoto end is denoted by ωt, and
a sum of the back focus of the zoom lens as the air conversion distance and a distance on an optical axis from a surface of the first lens on the object side to a lens surface of the final lens group closest to the image side in the state where the infinite distance object is in focus at the telephoto end is denoted by TLt,
Conditional Expressions (1), (2), (3), and (4) are satisfied, which are represented by
$$0 < fw / f 1 < 0.3 \qquad ( 1 )$$
$$0.5 < Fnot / ( ft / fw ) < 1.3 \qquad ( 2 )$$
$$0.15 < Bfw / ( ft \times tan ω t ) < 2 \qquad ( 3 )$$
$$7 < TLt / ( ft \times tan ω t ) t ) < 11. \qquad ( 4 )$$

2. The zoom lens according to claim 1,
wherein, in a case where a spacing on the optical axis between the intermediate group and the final lens group in the state where the infinite distance object is in focus at the telephoto end is denoted by dMEt, and
a spacing on the optical axis between the intermediate group and the final lens group in the state where the infinite distance object is in focus at the wide angle end is denoted by dMEw,
Conditional Expression (5) is satisfied, which is represented by
$$2 < dMEt / dMEw < 10. \qquad ( 5 )$$

3. The zoom lens according to claim 1,
wherein, in a case where a paraxial curvature radius of a lens surface of the second lens group closest to the object side is denoted by R2f, and
a paraxial curvature radius of the lens surface of the second lens group closest to the image side is denoted by R2r,
Conditional Expression (6) is satisfied, which is represented by
$$- 0.5 < ( R 2 f + R 2 r ) / ( R 2 f - R 2 r ) < 2. \qquad ( 6 )$$

4. The zoom lens according to claim 1,
wherein, in a case where a refractive index with respect to a d line for a lens closest to the image side in the first lens group is denoted by Nd1r,
an Abbe number based on the d line for the lens closest to the image side in the first lens group is denoted by vd1r,
a refractive index with respect to a d line for a lens closest to the image side in the second lens group is denoted by Nd2r, and
an Abbe number based on the d line for the lens closest to the image side in the second lens group is denoted by vd2r,
Conditional Expressions (7), (8), (9), and (10) are satisfied, which are represented by
$$1.65 < Nd 1 r < 1.8 \qquad ( 7 )$$
$$45 < vd 1 r < 60 \qquad ( 8 )$$
$$1.4 < Nd 2 r < 1 \text{.65} \qquad ( 9 )$$
$$60 < vd 2 r < 100. \qquad ( 10 )$$

5. The zoom lens according to claim 1,
wherein Conditional Expression (11) is satisfied, which is represented by
$$1 < fw / ( ft \times tan ω t ) < 1.45 . \qquad ( 11 )$$

6. The zoom lens according to claim 1,
wherein, in a case where a distance on the optical axis from the surface of the first lens on the object side to the aperture stop in the state where the infinite distance object is in focus at the wide angle end is denoted by DDL1STw, and
a sum of the back focus of the zoom lens as the air conversion distance and a distance on the optical axis from the surface of the first lens on the object side to the lens surface of the final lens group closest to the image side in the state where the infinite distance object is in focus at the wide angle end is denoted by TLw,
Conditional Expression (12) is satisfied, which is represented by
$$0 < DDL 1 STw / TLw < 0 \text{.65} . \qquad ( 12 )$$

7. The zoom lens according to claim 1,
wherein, in a case where a center thickness of the first lens is denoted by d1, and
an outer diameter of the first lens is denoted by DA1,
Conditional Expression (13) is satisfied, which is represented by
$$0.01 < d1 / DA 1 < 0.035 . \qquad ( 13 )$$

8. The zoom lens according to claim 1,
wherein, in a case where a center thickness of a negative lens closest to the image side among negative lenses included in the second lens group is denoted by d2r, and
an outer diameter of the negative lens closest to the image side among the negative lenses included in the second lens group is denoted by DA2r,
Conditional Expression (14) is satisfied, which is represented by
$$0.01 < d 2 r / DA 2 r < 0.04 . \qquad ( 14 )$$

9. The zoom lens according to claim 1,
wherein a focus group that moves along the optical axis during focusing is provided,
the focus group includes at least one negative lens, and
in a case where a center thickness of a negative lens closest to the image side among negative lenses included in the focus group is denoted by dffr, and
an outer diameter of the negative lens closest to the image side among the negative lenses included in the focus group is denoted by DAffr,
Conditional Expression (15) is satisfied, which is represented by
$$0.01 < dffr / DAffr < 0.04 . \qquad ( 15 )$$

10. The zoom lens according to claim 1,
wherein, in a case where a focal length of the final lens group is denoted by fE,
Conditional Expression (16) is satisfied, which is represented by
$$0 < f 1 / fE < 2. \qquad ( 16 )$$

11. The zoom lens according to claim 1,
wherein, in a case where a focal length of the second lens group is denoted by f2,
Conditional Expression (17) is satisfied, which is represented by
$$- 2 < fw / f 2 < - 0.7 . \qquad ( 17 )$$

12. The zoom lens according to claim 1,
wherein a focus group that moves along the optical axis during focusing is provided, and
in a case where a focal length of the second lens group is denoted by f2, and
a focal length of the focus group is denoted by ff,
Conditional Expression (18) is satisfied, which is represented by
$$0.2 < f 2 / ff < 0.8 . \qquad ( 18 )$$

13. The zoom lens according to claim 1,
wherein, in a case where a focal length of a lens group having a strongest positive refractive power among the lens groups included in the intermediate group is denoted by fMp,
Conditional Expression (19) is satisfied, which is represented by
$$0.4 < fw / fMp < 2. \qquad ( 19 )$$

14. The zoom lens according to claim 1,
wherein, in a case where a focal length of a lens group having a strongest positive refractive power among the lens groups included in the intermediate group is denoted by fMp,
Conditional Expression (20) is satisfied, which is represented by
$$1.5 < ft / fMp < 5. \qquad ( 20 )$$

15. The zoom lens according to claim 1,
wherein Conditional Expression (1-1) is satisfied, which is represented by
$$0.1 < fw / f 1 < 0.2 . \qquad ( 1 - 1 )$$

16. The zoom lens according to claim 1,
wherein the first lens group consists of three lenses.

17. The zoom lens according to claim 1,
wherein the second lens group consists of four lenses.

18. The zoom lens according to claim 1,
wherein the first lens group moves during the zooming.

19. The zoom lens according to claim 1,
wherein the zoom lens includes 14 or more lenses.

20. An imaging apparatus comprising:
the zoom lens according to claim 1.
